(19) United States
(12) Patent Application Publication
(10) Pub. No.: US 2017/0063112 A1
(43) Pub. Date: Mar. 2, 2017

(54) POWER STORAGE DEVICE WITH MONITORING IC

(71) Applicant: Semiconductor Energy Laboratory Co., Ltd., Atsugi-shi (JP)

(72) Inventor: Kei TAKAHASHI, Kanagawa (JP)

(21) Appl. No.: 15/238,793

(22) Filed: Aug. 17, 2016

(30) Foreign Application Priority Data
Aug. 31, 2015 (JP) 2015-170113

(51) Int. Cl. H02J 7/00; G09G 3/3225; G09G 3/36

(52) U.S. Cl. CPC H02J 7/0026; H02J 7/0021; G09G 3/3648; G09G 3/3225; G09G 2330/021; G09G 2300/0809; G09G 2310/0291

(57) ABSTRACT

A battery-monitoring IC with small power consumption is provided. A power storage device includes a storage element and an IC. The IC monitors the electromotive force of the power storage element. The IC includes a bias circuit, a holding circuit, and an amplifier. The holding circuit includes a first transistor and a capacitor. The amplifier includes a second transistor. The bias circuit is electrically connected to a gate of the second transistor through the first transistor. A first terminal of the capacitor is electrically connected to the gate of the second transistor. A first transistor preferably includes an oxide semiconductor in a channel formation region.

### BACKGROUND OF THE INVENTION

1. Field of the Invention

One embodiment of the present invention relates to a power storage device with a monitoring integrated circuit (IC).

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a memory device, a driving method thereof, or a manufacturing method thereof.

In this specification and the like, a semiconductor device generally means a device that can function by utilizing semiconductor characteristics. A display device, an electro-optical device, a semiconductor circuit, and an electronic device include a semiconductor device in some cases.

2. Description of the Related Art

Known is an IC which monitors the voltage of a battery used in a vehicle or an electronic device to prevent overcharge and overdischarge. For example, Patent Document 1 discloses a structure example of an IC which monitors a plurality of batteries connected in series.

Patent Document 2 discloses a semiconductor device whose power consumption is reduced with an operational amplifier provided with a holding circuit including an oxide semiconductor transistor (hereinafter referred to as an OS transistor).

### REFERENCE

### Patent Document

[Patent Document 1] Japanese Published Patent Application No. 2011-232161

[Patent Document 2] Japanese Published Patent Application No. 2013-235564

### SUMMARY OF THE INVENTION

A conventional battery-monitoring IC includes many amplifiers. It is necessary for operation of amplifiers that a reference voltage generation circuit and a bias circuit constantly operate. As a result, power consumption of the whole IC is increased, which causes a problem in that a battery is exhausted quickly.

An object of one embodiment of the present invention is to provide a low-power-consumption battery-monitoring IC. Another object of one embodiment of the present invention is to provide a novel power storage device. Another object of one embodiment of the present invention is to provide a novel semiconductor device.

Note that the description of a plurality of objects does not mutually preclude the existence. Note that one embodiment of the present invention does not necessarily achieve all the objects listed above. Objects other than those listed above are apparent from the description of the specification, drawings, claims, and the like, and such objects could be an object of one embodiment of the present invention.

One embodiment of the present invention is a power storage device including a power storage element and an IC. The IC is configured to monitor the electromotive force of the power storage element. The IC includes a first circuit, a second circuit, and a third circuit. The first circuit is configured to supply a bias voltage to the third circuit through the second circuit. The third circuit functions as an amplifier. The second circuit is configured to hold the bias voltage.

In the above embodiment, the second circuit includes a first transistor and a capacitor. The third circuit includes a second transistor. The first circuit is electrically connected to a gate of the second transistor through the first transistor. A first terminal of the capacitor is electrically connected to the gate of the second transistor. The first transistor preferably includes an oxide semiconductor in a channel formation region.

In the above embodiment, the IC preferably includes a timer. The timer determines a timing of turning on and off the first transistor.

One embodiment of the present invention is a power storage device including a plurality of power storage elements connected in series and an IC. The IC includes a circuit. The circuit is configured to select at least one of the plurality of power storage elements. The IC is configured to monitor the electromotive force of the power storage element selected by the circuit. The circuit preferably includes a transistor including an oxide semiconductor in a channel formation region.

One embodiment of the present invention is an electronic device including any of the above-described power storage devices and a display.

In the above embodiment, the display preferably includes a first display element and a second display element. The first display element preferably includes a reflective film. The reflective film has a function of reflecting incident light. The first display element is preferably configured to adjust the intensity of the reflected light. The reflective film preferably includes an opening. The second display element is preferably configured to emit light toward the opening.

In the above embodiment, it is preferable that the first display element include a liquid crystal element and the second display element include an organic EL element.

One embodiment of the present invention can provide a low-power-consumption battery-monitoring IC. One embodiment of the present invention can provide a novel power storage device. Furthermore, one embodiment of the present invention can provide a novel semiconductor device.

Note that the description of these effects does not disturb the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

In the accompanying drawings:

FIGS. 1A and 1B are circuit block diagrams each illustrating a structure example of a power storage device;

FIG. 2 is a circuit diagram illustrating a structure example of a power storage device;

FIG. 3 is a circuit block diagram illustrating a structure example of a battery-monitoring IC;

FIGS. 4A and 4B are circuit diagrams each illustrating a structure example of a switch included in a battery-monitoring IC;

FIG. 5 is a circuit diagram illustrating a structure example of a bias circuit, a holding circuit, and an amplifier included in a battery-monitoring IC;

FIG. 6 is a circuit diagram illustrating a structure example of a holding circuit included in a battery-monitoring IC;

FIG. 7 is a circuit block diagram illustrating a structure example of a display device;

FIG. 8 is a cross-sectional view illustrating a structure example of an IC;

FIGS. 9A and 9B are a cross-sectional view and a top view illustrating a structure example of a transistor;

FIG. 10 is a cross-sectional view illustrating a structure example of a transistor;

FIGS. 11A and 11B are a cross-sectional view and a top view illustrating a structure example of a transistor;

FIGS. 12A and 12B are a cross-sectional view and an energy band diagram of a channel portion of a transistor and its vicinity;

FIG. 13 is a cross-sectional view illustrating a structure example of an IC;

FIGS. 14A, 14B-1, and 14B-2 are bottom views illustrating a structure of a display panel;

FIGS. 15A to 15C are cross-sectional views illustrating a structure of a display panel;

FIG. 16 is a circuit diagram illustrating a pixel circuit;

FIGS. 17A, 17B-1, and 17B-2 illustrate a structure of a display panel;

FIGS. 18A and 18B are cross-sectional views illustrating a structure of a display panel; and

FIGS. 19A to 19F each illustrate an application example of a power storage device according to one embodiment of the present invention.

### DETAILED DESCRIPTION OF THE INVENTION

Hereinafter, embodiments will be described with reference to drawings. The embodiments can be implemented with various modes, and it will be readily appreciated by those skilled in the art that modes and details can be changed in various ways without departing from the spirit and scope of the present invention. Thus, the present invention should not be interpreted as being limited to the following description of the embodiments.

Furthermore, in the present specification, any of the embodiments described below can be combined as appropriate. In the case where some structure examples are given in one embodiment, any of the structure examples can be combined as appropriate.

In the drawings, the size, the layer thickness, or the region is exaggerated for clarity in some cases. Therefore, embodiments of the present invention are not limited to such a scale. Note that drawings are schematic views of ideal examples, and the embodiments of the present invention are not limited to the shape or the value illustrated in the drawings.

Unless otherwise specified, on-state current in this specification refers to drain current of a transistor in an on state. Unless otherwise specified, the on state of an n-channel transistor means that a voltage difference (Vgs) between its gate and source is larger than or equal to the threshold voltage (Vth), and the on state of a p-channel transistor means that Vgs is smaller than or equal to Vth. For example, the on-state current of an n-channel transistor sometimes refers to a drain current that flows when Vgs is larger than or equal to Vth. The on-state current of a transistor depends on a drain-source voltage (Vds) in some cases.

Unless otherwise specified, off-state current in this specification refers to drain current of a transistor in an off state. Unless otherwise specified, the off state of an n-channel transistor means that Vgs is smaller than Vth, and the off state of a p-channel transistor means that Vgs is larger than Vth. For example, the off-state current of an n-channel transistor sometimes refers to a drain current that flows when Vgs is lower than Vth. The off-state current of a transistor depends on Vgs in some cases. Thus, “the off-state current of a transistor is lower than 10⁻²¹ A” sometimes means that there is Vgs at which the off-state current of a transistor is lower than 10⁻²¹ A.

The off-state current of a transistor depends on Vds in some cases. Unless otherwise specified, the off-state current in this specification may be an off-state current at Vds with an absolute value of 0.1 V, 0.8 V, 1 V, 1.2 V, 1.8 V, 2.5 V, 3 V, 3.3 V, 10 V, 12 V, 16 V, or 20 V. Alternatively, the off-state current of a transistor might be an off-state current at Vds that is used in a semiconductor device or the like including the transistor.

### Embodiment 1

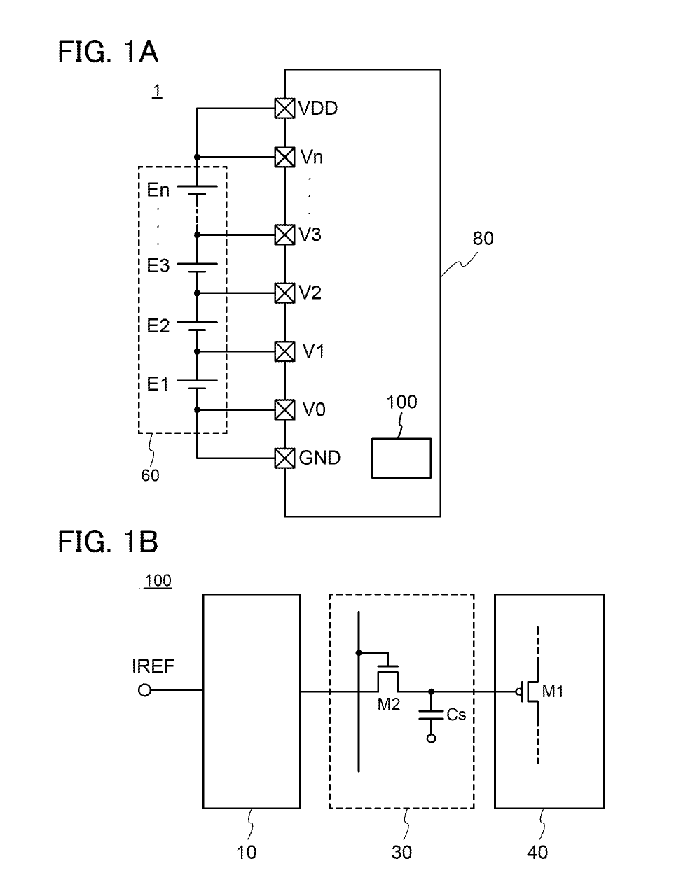

In this embodiment, structure examples of a power storage device of one embodiment of the present invention will be described with reference to FIGS. 1A and 1B, FIG. 2, FIG. 3, FIGS. 4A and 4B, FIG. 5, FIG. 6, and FIG. 7.

FIG. 1A is a circuit block diagram illustrating a structure example of a power storage device 1. The power storage device 1 illustrated in FIG. 1A includes a power storage element 60 and an IC 80.

The power storage element 60 includes power storage elements E1 to En connected in series (n is an integer of 2 or more). The power storage element 60 is electrically connected to the IC 80 through a terminal VDD, a terminal GND, and terminals V0 to Vn.

Note that the power storage element in this specification and the like refers to all elements that have the function of storing electric power. For example, a lithium-ion secondary battery, a lithium-ion capacitor, and an electric double layer capacitor are included in the category of the power storage device.

The IC 80 is configured to monitor the electromotive forces of the power storage elements E1 to En to control charge and discharge of the power storage element 60. The IC 80 can monitor the electromotive force of each power storage element by reading voltages of the terminals V0 to Vn. For example, the IC 80 can monitor the electromotive force of the power storage element E1 by reading the voltage between the terminal V0 and the terminal V1. For another example, the IC 80 can monitor the electromotive forces of the power storage elements E1 and E2 connected in series by reading the voltage between the terminal V0 and the terminal V2.

The IC 80 includes a circuit 100. FIG. 1B illustrates a structure example of the circuit 100. The circuit 100 includes a bias circuit 10, a holding circuit 30, and an amplifier 40.

The bias circuit 10 is configured to generate a bias voltage using a reference current supplied from a terminal IREF. The bias circuit 10 is also configured to supply the bias voltage to the amplifier 40 through the holding circuit 30. When the bias voltage is supplied to the amplifier 40, a bias current flows in the amplifier 40 and a signal is amplified thereby.

The holding circuit 30 includes a transistor M2 and a capacitor Cs. The amplifier 40 includes a transistor M1. Although the transistor M1 is a pMOS transistor in FIG. 1B, the transistor M1 is not necessarily a pMOS transistor and may be an nMOS transistor.

The bias circuit 10 is electrically connected to a gate of the transistor M1 through the transistor M2. A first terminal of the capacitor Cs is electrically connected to the gate of the transistor M1.

A transistor with a low off-state current is preferably used as the transistor M2. Examples of the transistor with a low off-state current include an OS transistor including an oxide semiconductor in a channel formation region and a transistor using a wide band gap semiconductor (with a band gap of 2.2 eV or more, such as silicon carbide, gallium nitride, or diamond) in a channel formation region.

The holding circuit 30 can hold a bias voltage when the transistor M2 is turned off after the bias voltage is supplied to the gate of the transistor M1. Since the off-state current of the transistor M2 is extremely low, charges stored in the capacitor Cs can be held for a long time after the transistor M2 is turned off. The potential supplied to the gate of the transistor M1 is also held when the charges of the capacitor Cs are held. In other words, the holding circuit 30 can hold the bias voltage supplied to the amplifier 40 for a long time.

At this time, the bias circuit 10 can stop operating. Specifically, supply of the reference current from the terminal IREF can be stopped. Since the holding circuit 30 holds the bias voltage, the amplifier 40 can keep a state in which the bias voltage is applied thereto and can operate even when the bias circuit 10 stops operating.

For example, in the case where the holding circuit 30 is not provided, the bias circuit 10 must keep operating in order that the amplifier 40 keeps operating. Since a steady-state current flows in driving of the bias circuit 10, the bias circuit 10 consumes electric power, which leads to quick exhaustion of electric power of the power storage element 60.

On the other hand, since the circuit 100 includes the holding circuit 30, the amplifier 40 can operate even when the bias circuit 10 stops operating, leading to reduction in power consumption of the IC 80. As a result, the electric power of the power storage element 60 can be saved.

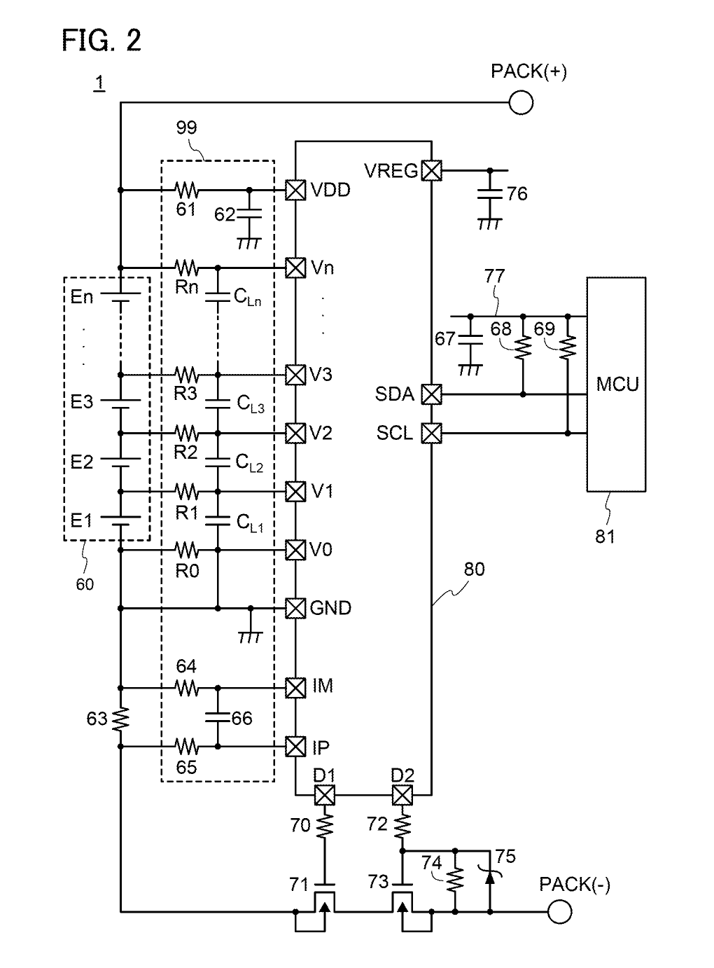

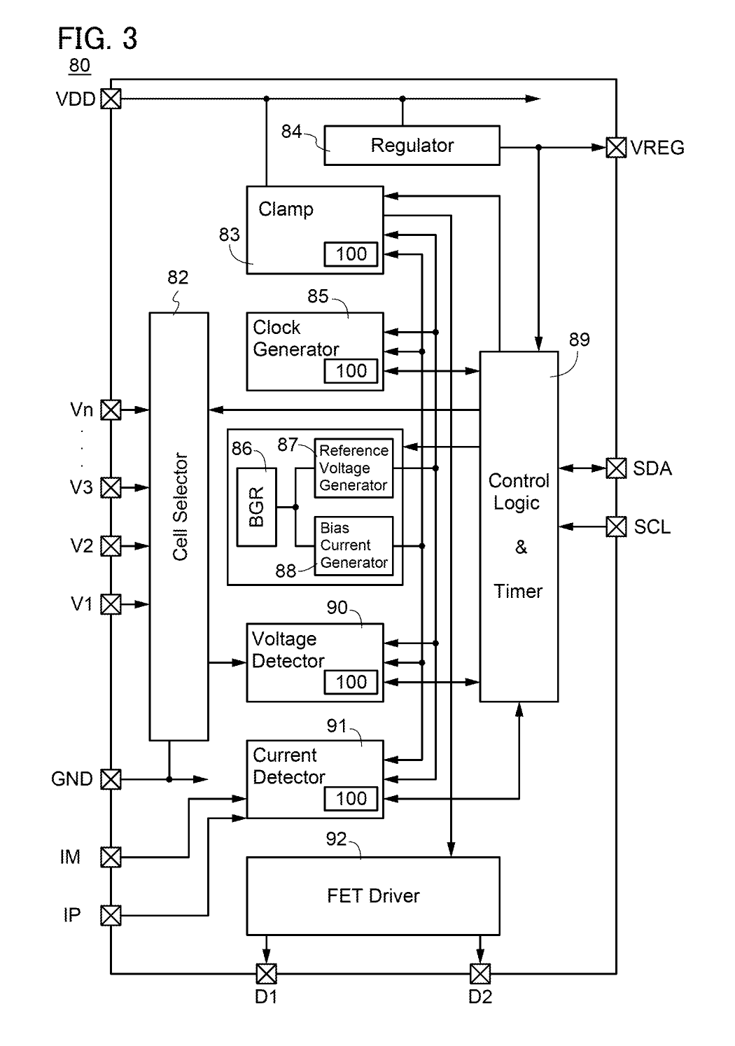

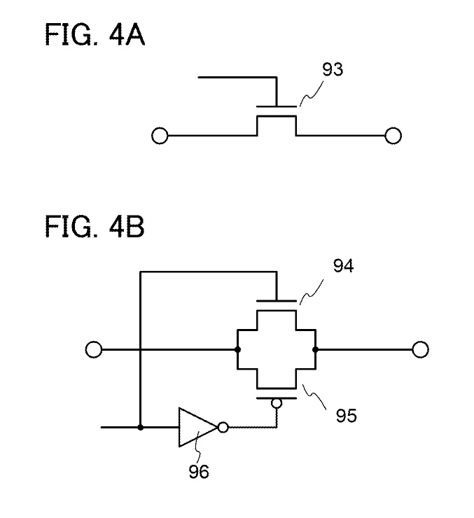

A structure example of the power storage device 1 is described in detail with reference to FIG. 2, FIG. 3, FIGS. 4A and 4B, FIG. 5, and FIG. 6.

### <Power Storage Device 1>

FIG. 2 is a detailed circuit diagram illustrating the power storage device 1 in FIG. 1A. In addition to the components illustrated in FIG. 1A, the power storage device 1 includes a low-pass filter 99, a resistor 63, a resistor 70, a resistor 72, a field-effect transistor (FET) 71, an FET 73, a resistor 74, a Zener diode 75, a capacitor 76, a microcontroller 81, a resistor 68, a resistor 69, a capacitor 67, and the like. The power storage device 1 is configured to supply a voltage generated in the power storage element 60 to an external circuit through a terminal PACK(+) and a terminal PACK(−).

The IC 80 includes a terminal VREG, a terminal SDA, a terminal SCL, a terminal IM, a terminal IP, a terminal D1, and a terminal D2 in addition to the terminals illustrated in FIG. 1A.

The low-pass filter 99 includes resistors R0 to Rn, capacitors C_{L1} to C_{Ln}, a resistor 61, a capacitor 62, a resistor 64, a resistor 65, and a capacitor 66. The low-pass filter 99 is configured to remove noise generated by the power storage element 60.

The IC 80 is configured to monitor a current flowing from the power storage element 60 with the use of the terminal IM and the terminal IP.

The IC 80 is configured to control on and off states of the FET 71 connected to the terminal D1. The IC 80 is also configured to control on and off states of the FET 73 connected to the terminal D2. For example, in the case where the IC 80 detects overcharge or overdischarge of the power storage element 60, the IC 80 can make the FET 71 and the FET 73 turn off to stop charge and discharge of the power storage element 60.

The IC 80 is connected to the capacitor 76 through the terminal VREG. The capacitor 76 is supplied with a voltage regulated by a regulator 84 described later.

The IC 80 exchanges signals between the microcontroller 81 through the terminal SDA or the terminal SCL. The resistors 68 and 69 and the capacitor 67 are connected to a wiring 77. The wiring 77 is supplied with a driving voltage of the microcontroller 81.

The microcontroller 81 receives information as to the electromotive forces of the power storage elements E1 to En from the IC 80, and then sends an instruction based thereon to the IC 80. The IC 80 controls charge and discharge of the power storage element 60 in accordance with the instruction from the microcontroller 81.

### <IC 80>

FIG. 3 is a circuit block diagram illustrating an internal structure example of the IC 80. The IC 80 includes a selector 82, a clamp circuit 83, the regulator 84, a clock generator 85, a band gap reference 86, a reference voltage generator 87, a reference current generator 88, a control circuit 89, a voltage detector 90, a current detector 91, and an FET driver 92.

The selector 82 is configured to select at least one of the power storage elements E1 to En. The electromotive force of the power storage element selected by the selector 82 is monitored. The selector 82 includes a plurality of switches. The switches are preferably elements that can withstand a high voltage because a high voltage is applied to the selector 82.

FIGS. 4A and 4B each illustrate an example of a switch that can be used for the selector 82. FIG. 4A illustrates an example in which a transistor 93 is used as the switch. A transistor in which a material having a high dielectric breakdown field is used for a channel formation region is preferably used as the transistor 93. Examples of the transistor include an OS transistor including an oxide semiconductor in a channel formation region and a transistor using a wide band gap semiconductor (with a band gap of 2.2 eV or more, such as silicon carbide, gallium nitride, or diamond) in a channel formation region.

FIG. 4B illustrates an example in which a transistor 94, a transistor 95, and an inverter 96 are used as the switch. The transistor 94 is an n-channel transistor and the transistor 95 is a p-channel transistor. The transistor 94 may be the OS transistor or the transistor using a wide band gap semiconductor described above. The transistor 95 may be the transistor using a wide band gap semiconductor described above.

The voltage detector 90 is configured to detect the electromotive force of the power storage element selected by the selector 82.

The current detector 91 is configured to detect a current flowing from the power storage element 60.

The clock generator 85 is configured to generate a clock signal and supplying it to the control circuit 89.

The control circuit 89 is a logic circuit. The control circuit 89 receives signals from the voltage detector 90 and the current detector 91 and controls on and off states of the switches included in the selector 82.

The regulator 84 is configured to regulate the voltage supplied from the terminal VDD to be a certain constant voltage. The voltage regulated by the regulator 84 is supplied to the control circuit 89. Since the voltage supplied from the terminal VDD is high in many cases, the control circuit 89 might be damaged when the terminal VDD is directly connected to the control circuit 89. Therefore, the voltage needs to be regulated by the regulator 84.

The clamp circuit 83 and the FET driver 92 are configured to protect the circuits connected to the power storage element 60 from overvoltage. When the clamp circuit 83 detects overvoltage, it sends a signal to the FET driver 92. The FET driver 92 makes the FET 71 and the FET 73 turn off once it receives the signal. As a result, the power storage element 60 stops charge and discharge, and thus, the circuits connected to the power storage element 60 can be prevented from breaking down.

The band gap reference 86 is configured to generate a voltage. The reference voltage generator 87 is configured to generate a reference voltage on the basis of the voltage generated by the band gap reference 86. The reference current generator 88 is configured to generate a reference current on the basis of the voltage generated by the band gap reference 86.

The clamp circuit 83, the clock generator 85, the voltage detector 90, and the current detector 91 each include the circuit 100 illustrated in FIG. 1B. The above-described reference voltage and reference current are supplied to the circuit 100 included in each circuit.

The control circuit 89 includes a timer. In each of the circuits 100 included in the clamp circuit 83, the clock generator 85, the voltage detector 90, and the current detector 91, the OS transistor of the holding circuit 30 can be turned off and the bias circuit 10 can stop operating in accordance with the timing determined by the timer. As a result, the power consumption of the whole IC 80 can be reduced. Note that the band gap reference 86, the reference voltage generator 87, and the reference current generator 88 are stopped in order that the bias circuits 10 are stopped.

### <Circuit 100>

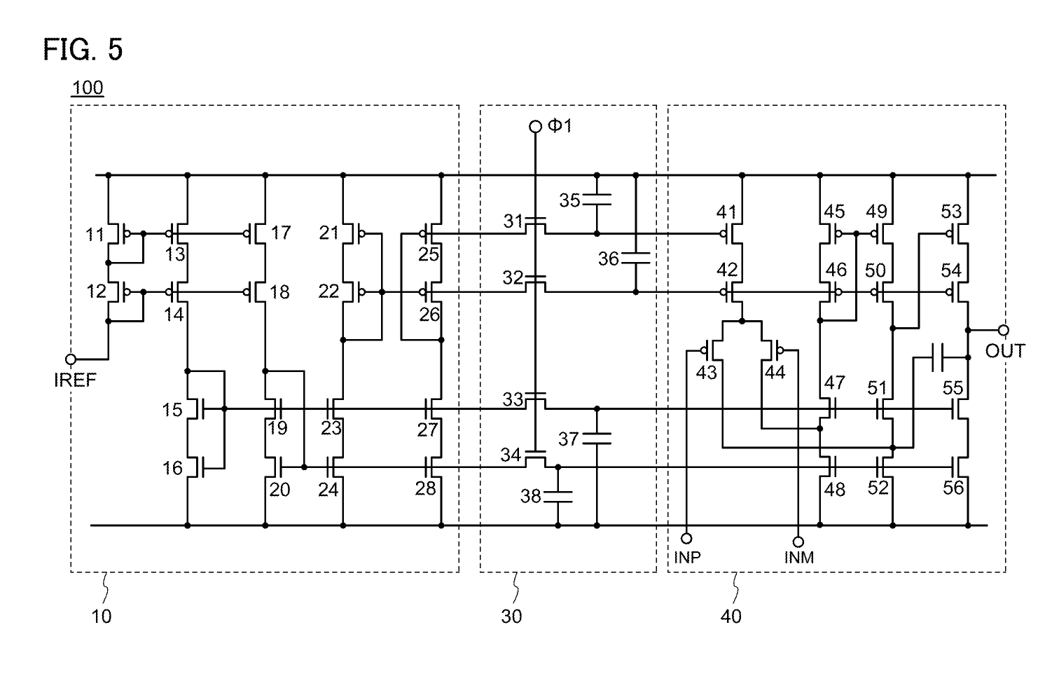

A circuit diagram in FIG. 5 illustrates a structure example of the circuit 100 in FIG. 1B.

The bias circuit 10 illustrated in FIG. 5 includes transistors 11 to 28. The reference current generated by the reference current generator 88 is supplied to the terminal IREF. When the reference current generator 88 stops operating and the supply of the reference current stops, the bias circuit 10 also stops operating. As described with reference to FIG. 1B, the bias circuit 10 is configured to supply the bias voltage to the amplifier 40.

The holding circuit 30 illustrated in FIG. 5 includes transistors 31 to 34 and capacitors 35 to 38. Gates of the transistors 31 to 34 are connected to a terminal φ1. The transistors 31 to 34 turn on or off in accordance with the level of the potential supplied to the terminal φ1.

A transistor with low off-state current is preferably used as each of the transistors 31 to 34 as in the case of the transistor M2 in FIG. 1B. The bias voltage is supplied to the amplifier 40 and then the transistors 31 to 34 are turned off, so that the charges of the capacitors 35 to 38 are held and the holding circuit 30 holds the bias voltage.

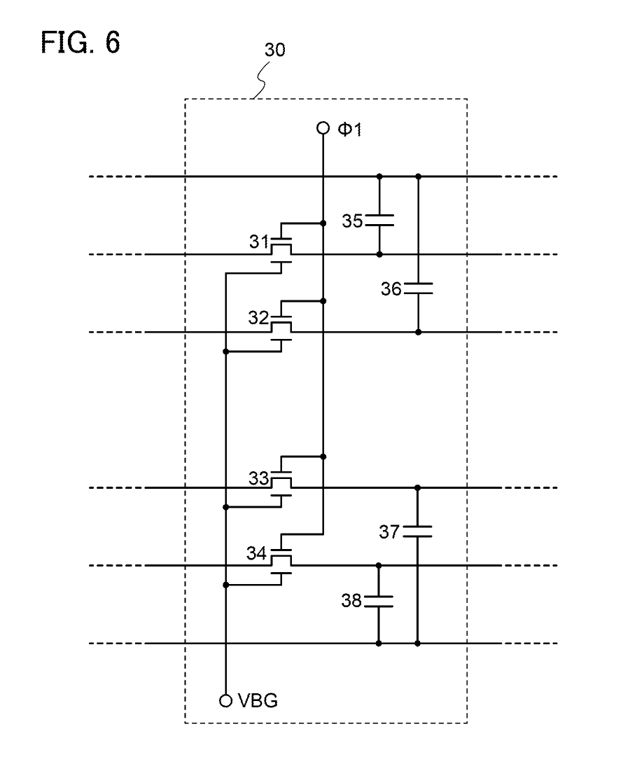

Each of the transistors 31 to 34 may be provided with a second gate. FIG. 6 is a circuit diagram in that case. Each of the second gates of the transistors 31 to 34 is connected to a terminal VBG. In each of the transistors 31 to 34, the first gate and the second gate preferably include regions overlapping with each other with a semiconductor layer provided therebetween. The terminal φ1 and the terminal VBG may be supplied with different potentials or the same potential. With the second gates, the threshold voltages of the transistors 31 to 34 can be controlled and the on-state current can be increased.

The amplifier 40 illustrated in FIG. 5 includes transistors 41 to 56. A terminal INP functions as a non-inverting input terminal of the amplifier 40, a terminal INM functions as an inverting input terminal of the amplifier 40, and a terminal OUT functions as an output terminal of the amplifier 40.

### <Mode Including Display>

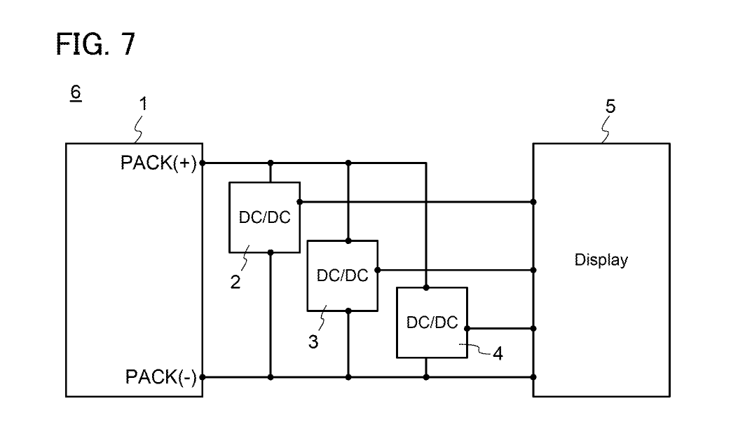

FIG. 7 is a circuit block diagram of a display device 6. The display device 6 is a mode in which a display 5 is added to the above power storage device 1. The power storage device 1 is electrically connected to the display 5 through a DC/DC converter 2, a DC/DC converter 3, and a DC/DC converter 4.

The DC/DC converter 2 is a step-up DC/DC converter and configured to raise a voltage supplied from the power storage device 1 to supply the display 5.

The DC/DC converter 3 is a step-down DC/DC converter and configured to lower a voltage supplied from the power storage device 1 to supply the display 5.

The DC/DC converter 4 is an inverting DC/DC converter and configured to convert a voltage supplied from the power storage device 1 into a voltage of opposite polarity (e.g., converting +10 V into −10 V) to supply the display 5.

The display device 6 can display the amount of power stored in the storage element on the display 5. Furthermore, the display device 6 is mounted on an electronic device, whereby an electronic device with small battery power consumption can be provided.

### Embodiment 2

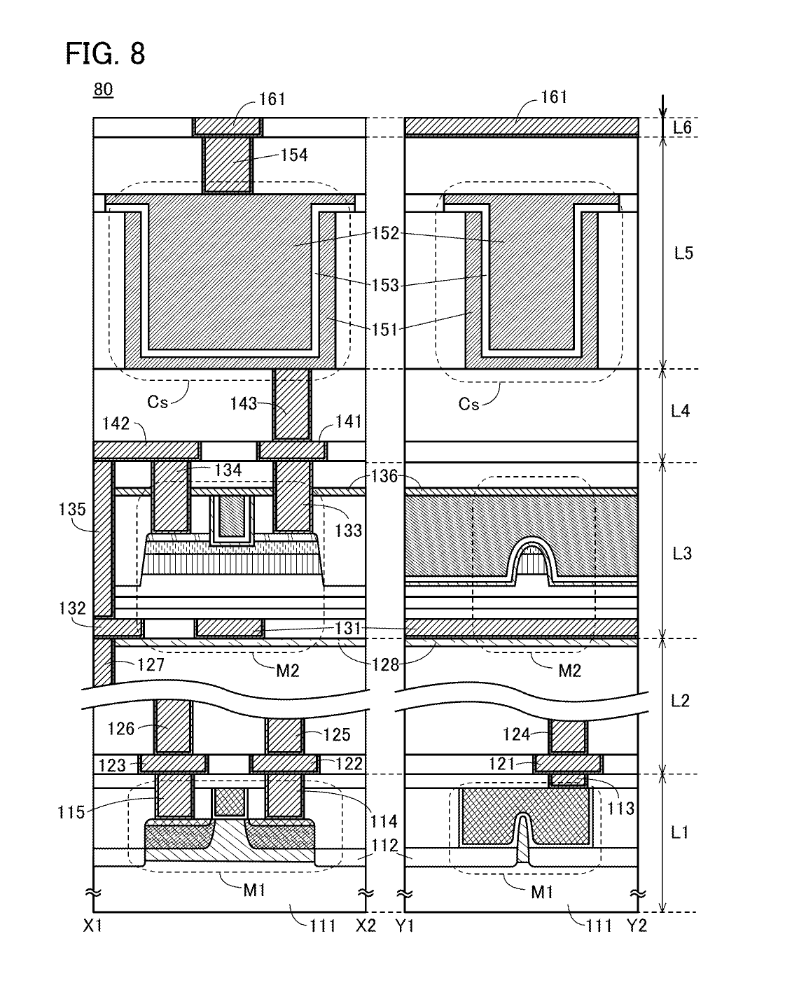

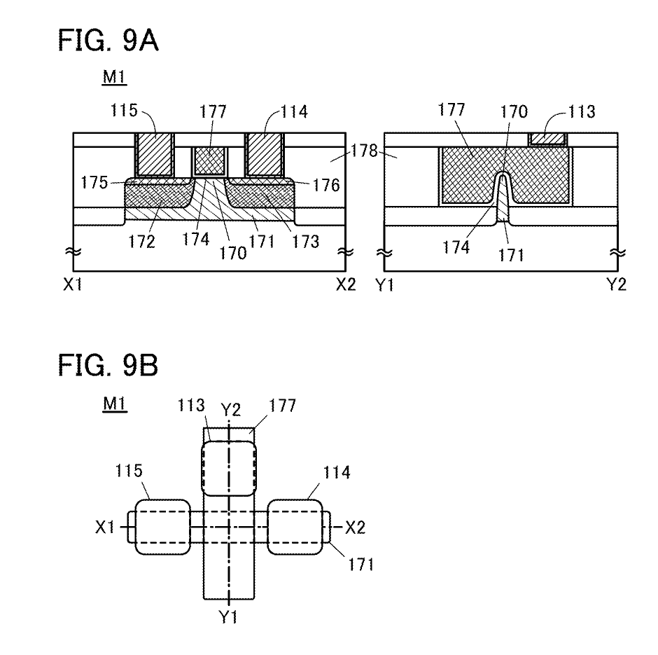

In this embodiment, a structure example of a device applicable to the IC 80 described in Embodiment 1 is described with reference to FIG. 8, FIGS. 9A and 9B, FIG. 10, FIGS. 11A and 11B, FIGS. 12A and 12B, and FIG. 13.

### <Structure Example 1 of Semiconductor Device>

FIG. 8 is a cross-sectional view of the IC 80. The IC 80 illustrated in FIG. 8 includes the transistor M1, the transistor M2, and the capacitor Cs. A left part of FIG. 8 is a cross-sectional view of the IC 80 in the channel length directions of the transistors M1 and M2, and a right part of FIG. 8 is a cross-sectional view of the IC 80 in the channel width directions of the transistors M1 and M2.

The IC 80 includes a layer L1, a layer L2, a layer L3, a layer L4, a layer L5, and a layer L6 stacked in this order from the bottom.

The layer L1 includes the transistor M1, a substrate 111, an element separation layer 112, a plug 113, a plug 114, a plug 115, and the like.

The layer L2 includes a wiring 121, a wiring 122, a wiring 123, a plug 124, a plug 125, a plug 126, a plug 127, an insulator 128, and the like.

The layer L3 includes the transistor M2, a wiring 131, a wiring 132, a plug 133, a plug 134, a plug 135, an insulator 136, and the like.

The layer L4 includes a wiring 141, a wiring 142, a plug 143, and the like.

The layer L5 includes the capacitor Cs, a plug 154, and the like.

The layer L6 includes a wiring 161 and the like.

The transistor M1 illustrated in FIG. 8 can be used as any of the transistor M1 in FIG. 1B, the transistors 11 to 28 in FIG. 5, the transistors 41 to 56 in FIG. 5, the transistor 95 in FIG. 4B, and the like.

The transistor M2 illustrated in FIG. 8 can be used as any of the transistor M2 in FIG. 1B, the transistors 31 to 34 in FIG. 5, the transistor 93 in FIG. 4A, the transistor 94 in FIG. 4B, and the like.

The transistor M2 preferably includes a semiconductor having a wider band gap and lower intrinsic carrier density than silicon or the like in a channel formation region. As such a transistor, for example, an OS transistor including an oxide semiconductor in a channel formation region can be given.

In the case where an OS transistor is used as the transistor M2, the insulators 128 and 136 each preferably have a function of blocking oxygen, hydrogen, water, an alkali metal, an alkaline earth metal, or the like. With the insulators 128 and 136, diffusion of oxygen contained in the transistor M2 to the outside and entry of hydrogen, moisture, or the like into the transistor M2 from the outside can be prevented.

The insulators 128 and 136 can be, for example, a nitride insulator. Examples of the nitride insulator include silicon nitride, silicon nitride oxide, aluminum nitride, and aluminum nitride oxide. Note that instead of the nitride insulator, an oxide insulator having a blocking effect against oxygen, hydrogen, water, and the like may be provided. Examples of the oxide insulator include aluminum oxide, aluminum oxynitride, gallium oxide, gallium oxynitride, yttrium oxide, yttrium oxynitride, hafnium oxide, and hafnium oxynitride. An aluminum oxide film is particularly preferably used as each of the insulators 128 and 136 because it is highly effective in preventing permeation of both oxygen and impurities such as hydrogen and moisture.

The transistors M1 is provided over the substrate 111 and isolated from another adjacent transistor by the element isolation layer 112. For the element isolation layer 112, silicon oxide, silicon oxynitride, silicon nitride oxide, silicon nitride, or the like can be used. Note that in this specification, an oxynitride refers to a compound that contains more oxygen than nitrogen, and a nitride oxide refers to a compound that contains more nitrogen than oxygen.

As the substrate 111, a single crystal semiconductor substrate or a polycrystalline semiconductor substrate of silicon or silicon carbide, a compound semiconductor substrate of silicon germanium, a silicon-on-insulator (SOI) substrate, or the like can be used. Alternatively, a glass substrate, a quartz substrate, a plastic substrate, a metal substrate, an attachment film, paper including a fibrous material, or a base film may be used as the substrate 111, for example. Alternatively, a semiconductor element may be formed using one substrate, and then transferred to another substrate.

Alternatively, a flexible substrate may be used as the substrate 111. As a method for providing a transistor over a flexible substrate, there is a method in which the transistor is formed over a non-flexible substrate and then the transistor is separated and transferred to the substrate 111 which is a flexible substrate. In that case, a separation layer is preferably provided between the non-flexible substrate and the transistor. As the substrate 111, a sheet, a film, or a foil containing a fiber may be used. The substrate 111 may have elasticity. The substrate 111 may have a property of returning to its original shape when bending or pulling is stopped. Alternatively, the substrate 111 may have a property of not returning to its original shape. The thickness of the substrate 111 is, for example, greater than or equal to 5 μm and less than or equal to 700 μm, preferably greater than or equal to 10 μm and less than or equal to 500 μm, further preferably greater than or equal to 15 μm and less than or equal to 300 μm. When the substrate 111 has a small thickness, the weight of the semiconductor device can be reduced. When the substrate 111 has a small thickness, even in the case of using glass or the like, the substrate 111 may have elasticity or a property of returning to its original shape when bending or pulling is stopped. Therefore, an impact applied to the semiconductor device over the substrate 111, which is caused by dropping or the like, can be reduced. That is, a durable semiconductor device can be provided. For the substrate 111 which is a flexible substrate, for example, metal, an alloy, resin, glass, or fiber thereof can be used. The flexible substrate 111 preferably has a lower coefficient of linear expansion because deformation due to an environment is suppressed. The flexible substrate 111 is formed using, for example, a material whose coefficient of linear expansion is lower than or equal to 1×10⁻³/K, lower than or equal to 5×10⁻⁵/K, or lower than or equal to 1×10⁻⁵/K. Examples of the resin include polyester, polyolefin, polyamide (e.g., nylon or aramid), polyimide, polycarbonate, acrylic, and polytetrafluoroethylene (PTFE). In particular, aramid is preferably used for the flexible substrate 111 because of its low coefficient of linear expansion.

In the example illustrated in FIG. 8, a single crystal silicon wafer is used as the substrate 111.

The capacitor Cs includes a conductor 151, a conductor 152, and an insulator 153. The conductors 151 and 152 serve as electrodes of the capacitor Cs. The insulator 153 serves as a capacitor insulator of the capacitor Cs.

The insulator 153 preferably contains an insulator with a high relative dielectric constant. For example, the insulator 153 preferably contains silicon oxide, silicon oxynitride, silicon nitride, silicon nitride oxide, gallium oxide, hafnium oxide, an oxide containing aluminum and hafnium, an oxynitride containing aluminum and hafnium, an oxide containing silicon and hafnium, or an oxynitride containing silicon and hafnium.

The conductors 151 and 152 each preferably have a single-layer structure or a layered structure of a conductor containing a low-resistance material selected from copper, tungsten, molybdenum, gold, aluminum, manganese, titanium, tantalum, nickel, chromium, lead, tin, iron, cobalt, ruthenium, platinum, iridium, and strontium, an alloy of such a low-resistance material, or a compound containing such a material as its main component. It is particularly preferable to use a high-melting-point material which has both heat resistance and conductivity, such as tungsten or molybdenum. In addition, each of the conductors 151 and 152 is preferably formed using a low-resistance conductive material such as aluminum or copper.

In particular, in the case where the insulator 153 contains a metal oxide, the conductors 151 and 152 preferably contain noble metal such as iridium, ruthenium, platinum, or strontium ruthenate. Such noble metal hardly takes oxygen from the insulator 153 even when in contact with the metal oxide contained in the insulator 153, and hardly generates defects due to oxygen vacancies in the insulator 153.

The wirings and the plugs illustrated in FIG. 8 each preferably have a single-layer structure or a layered structure of a conductor containing a low-resistance material selected from copper, tungsten, molybdenum, gold, aluminum, manganese, titanium, tantalum, nickel, chromium, lead, tin, iron, cobalt, ruthenium, platinum, iridium, and strontium, an alloy of such a low-resistance material, or a compound containing such a material as its main component. It is particularly preferable to use a high-melting-point material which has both heat resistance and conductivity, such as tungsten or molybdenum. In addition, each of the wirings and the plugs is preferably formed using a low-resistance conductive material such as aluminum or copper. Each of the wirings and the plugs is more preferably formed using an alloy of copper and manganese, in which case manganese oxide formed at the interface with an insulator containing oxygen has a function of preventing diffusion of copper.

Alternatively, the wirings and the plugs illustrated in FIG. 8 may be formed using a transparent conductive material containing indium oxide, tin oxide, or zinc oxide. As the transparent conductive material, for example, indium oxide, indium tin oxide, indium zinc oxide, zinc oxide, zinc oxide to which gallium is added, or the like can be used.

Alternatively, the wirings and the plugs illustrated in FIG. 8 may have a layered structure of any of the above metals and any of the above transparent conductive materials.

The transistor M1 and the transistor M2 are described below in detail with reference to FIGS. 9A and 9B, FIG. 10, and FIGS. 11A and 11B.

### <Transistor M1>

FIG. 9A illustrates the layer L1 in the cross-sectional view of FIG. 8. FIG. 9B is a top view of the transistor M1. Note that for simplification, some components are not illustrated in the top view of FIG. 9B. A left part of FIG. 9A shows a cross-sectional view taken along dashed-dotted line X1-X2 in FIG. 9B and a right part of FIG. 9A shows a cross-sectional view taken along dashed-dotted line Y1-Y2 in FIG. 9B. In some cases, the direction of dashed-dotted line X1-X2 is referred to as a channel length direction of the transistor M1 and the direction of dashed-dotted line Y1-Y2 is referred to as a channel width direction of the transistor M1.

The transistor M1 includes a channel formation region 170 and impurity regions 172 and 173 provided in a well 171, conductive regions 175 and 176 provided in contact with the impurity regions 172 and 173, a gate insulator 174 provided over the channel formation region 170, and a gate electrode 177 provided over the gate insulator 174. The conductive regions 175 and 176 may be formed using a metal silicide or the like.

In the transistor M1 in FIG. 9A, the channel formation region 170 has a projecting portion, and the gate insulator 174 and the gate electrode 177 are provided along side and top surfaces of the projecting portion. The transistor with such a shape is referred to as a FIN-type transistor. Although the projecting portion is formed by processing part of the semiconductor substrate in this embodiment, it may be formed by processing an SOI substrate.

FIG. 9A illustrates an example in which a Si transistor is used as the transistor M1. The transistor M1 may be either an n-channel transistor or a p-channel transistor; an appropriate transistor is used depending on a circuit.

The insulator 178 serves as an interlayer insulator. In the case where a Si transistor is used as the transistor M1, the insulator 178 preferably contains hydrogen. When the insulator 178 contains hydrogen, dangling bonds of silicon can be terminated and thus the reliability of the transistor M1 can be improved. For the insulator 178, silicon oxide, silicon oxynitride, silicon nitride oxide, silicon nitride, or the like is preferably used.

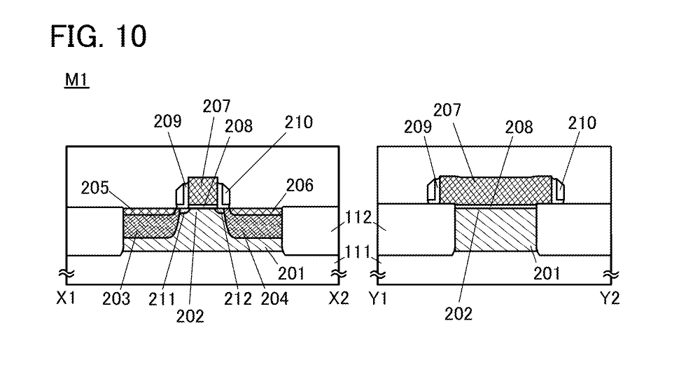

Note that the transistor M1 may be a planar transistor. An example of such a case is illustrated in FIG. 10. The transistor M1 illustrated in FIG. 10 includes a channel formation region 202, low-concentration impurity regions 211 and 212, and high-concentration impurity regions 203 and 204 provided in a well 201; conductive regions 205 and 206 provided in contact with the high-concentration impurity regions 203 and 204; a gate insulator 208 provided over the channel formation region 202; a gate electrode 207 provided over the gate insulator 208; and sidewall insulating layers 209 and 210 provided on sidewalls of the gate electrode 207. The conductive regions 205 and 206 may be formed using a metal silicide or the like.

### <Transistor M2>

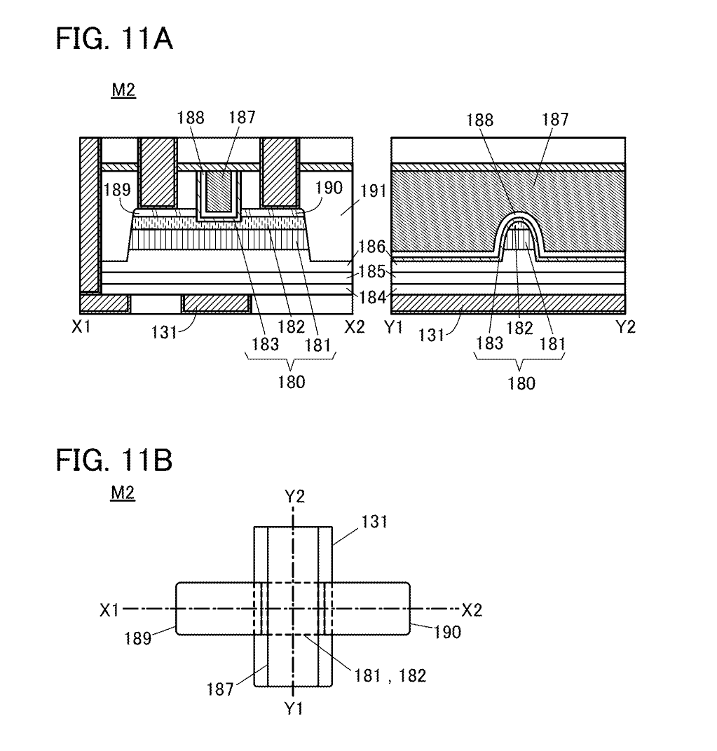

FIG. 11A illustrates the layer L3 in the cross-sectional view of FIG. 8. FIG. 11B is a top view of the transistor M2. Note that for simplification, some components are not illustrated in the top view of FIG. 11B. A left part of FIG. 11A shows a cross-sectional view taken along dashed-dotted line X1-X2 in FIG. 11B and a right part of FIG. 11A shows a cross-sectional view taken along dashed-dotted line Y1-Y2 in FIG. 11B. In some cases, the direction of dashed-dotted line X1-X2 is referred to as a channel length direction of the transistor M2 and the direction of dashed-dotted line Y1-Y2 is referred to as a channel width direction of the transistor M2.

The transistor M2 includes the wiring 131; an insulator 184 formed so as to cover the wiring 131; an insulator 185 over the insulator 184; an insulator 186 over the insulator 185; a stack in which an oxide semiconductor 181 and an oxide semiconductor 182 are stacked in this order over the insulator 186; a conductor 189 in contact with a top surface of the oxide semiconductor 182; a conductor 190 in contact with the top surface of the oxide semiconductor 182; an insulator 191 over the conductors 189 and 190; an oxide semiconductor 183 in contact with the oxide semiconductors 181 and 182, the conductors 189 and 190, and the insulator 191; an insulator 188 over the oxide semiconductor 183; and a conductor 187 over the insulator 188. The oxide semiconductor 181, the oxide semiconductor 182, and the oxide semiconductor 183 are collectively called an oxide semiconductor 180.

The oxide semiconductor 182 is a semiconductor and serves as a channel formation region of the transistor M2.

In the transistor M2, the oxide semiconductor 181 or the oxide semiconductor 183 includes a region through which electrons do not pass (a region which does not serve as a channel). For that reason, in the transistor M2, the oxide semiconductor 181 or the oxide semiconductor 183 is also referred to as an insulator.

The conductor 189 serves as one of a source electrode and a drain electrode of the transistor M2. The conductor 190 serves as the other of the source electrode and the drain electrode of the transistor M2.

The conductor 187 serves as a first gate electrode of the transistor M2.

The insulator 188 serves as a first gate insulator of the transistor M2.

The wiring 131 serves as a second gate electrode of the transistor M2.

The conductor 187 and the wiring 131 may be supplied with the same potential or different potentials. Note that the wiring 131 may be omitted in some cases.

The insulators 184 to 186 serve as a base insulator of the transistor M2 and a second gate insulator of the transistor M2.

The insulator 191 serves as a protective insulator or an interlayer insulator of the transistor M2.

As illustrated in FIG. 11A, the side surface of the oxide semiconductor 182 is surrounded by the conductor 187. With this structure, the oxide semiconductor 182 can be electrically surrounded by an electric field of the conductor 187. Such a structure of a transistor in which a semiconductor is electrically surrounded by an electric field of a gate electrode is referred to as a surrounded channel (s-channel) structure. Therefore, a channel is formed in the entire oxide semiconductor 182 (bulk). In the s-channel structure, a large amount of current can flow between a source and a drain of a transistor, increasing the on-state current of the transistor.

The s-channel structure, because of its high on-state current, is suitable for a semiconductor device which requires a miniaturized transistor, such as a large-scale integrated (LSI) circuit. A semiconductor device including the miniaturized transistor can have a high integration degree and high density.

The conductor 187 serving as the gate electrode is formed in a self-aligned manner so as to fill an opening formed in the insulator 191. As illustrated in FIG. 11A, the conductor 187 and the conductor 189 preferably do not overlap with each other. Furthermore, the conductor 187 and the conductor 190 preferably do not overlap with each other. With such a structure, the parasitic capacitance generated between the conductor 187 and the conductor 189 or between the conductor 187 and the conductor 190 can be lower, and thus a reduction in the operation speed of the transistors M2 can be prevented.

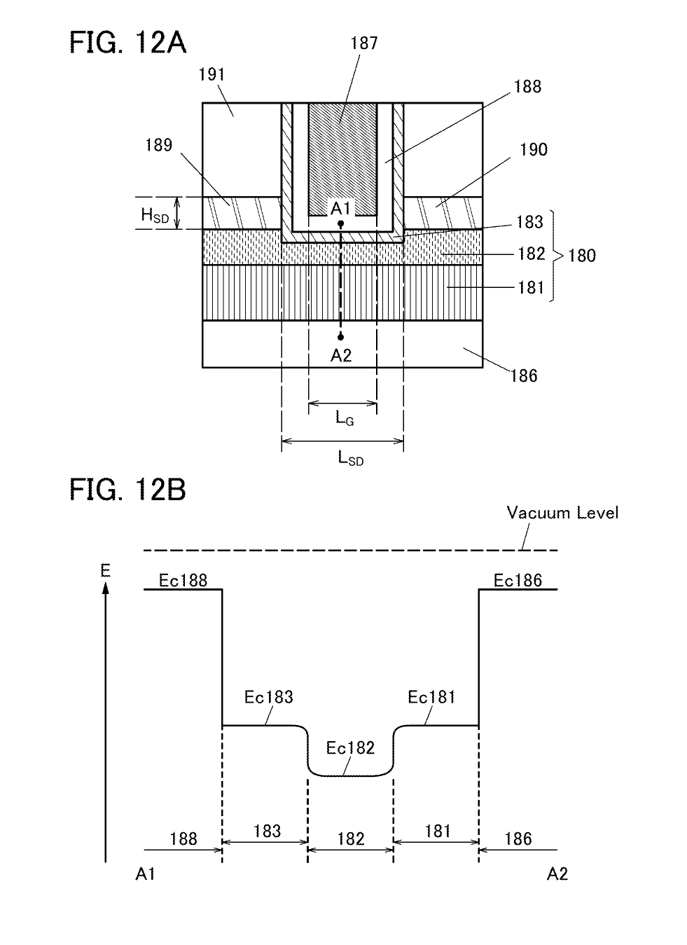

FIG. 12A is an enlarged view of the center portion of the transistor M2. In FIG. 12A, a width L_{G} denotes the length of the bottom surface of the conductor 187, which faces and lies parallel to the top surface of the oxide semiconductor 182 with the insulator 188 and the oxide semiconductor 183 positioned therebetween. The width L_{G} is the line width of the gate electrode. In FIG. 12A, a width L_{SD} denotes the length between the conductors 189 and 190, i.e., the length between the source electrode and the drain electrode.

The width L_{SD} is generally determined by the minimum feature size. As illustrated in FIG. 12A, the width L_{G} is narrower than the width L_{SD}. This means that in the transistor M2, the line width of the gate electrode can be made narrower than the minimum feature size; specifically, the width L_{G} can be greater than or equal to 5 nm and less than or equal to 60 nm, preferably greater than or equal to 5 nm and less than or equal to 30 nm.

In FIG. 12A, a height H_{SD} denotes the thickness of the conductor 189 or the thickness of the conductor 190.

The thickness of the insulator 188 is preferably less than or equal to the height H_{SD}, in which case the electric field of the gate electrode can be applied to the entire channel formation region. The thickness of the insulator 188 is less than or equal to 30 nm, preferably less than or equal to 10 nm.

Components of the transistor M2 will be described below.

### <Oxide Semiconductor>

First, an oxide semiconductor that can be used as the oxide semiconductors 181 to 183 will be described.

The oxide semiconductor 182 is an oxide semiconductor containing indium (In), for example. The oxide semiconductor 182 can have high carrier mobility (electron mobility) by containing indium, for example. The oxide semiconductor 182 preferably contains an element M. The element M is preferably aluminum (Al), gallium (Ga), tin (Sn), or the like. Other elements that can be used as the element M are, for example, boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that two or more of the above elements may be used in combination as the element M. The element M is an element having high bonding energy with oxygen, for example. The element M is an element whose bonding energy with oxygen is higher than that of indium, for example. The element M is an element that can increase the energy gap of the oxide semiconductor, for example. Furthermore, the oxide semiconductor 182 preferably contains zinc (Zn). When containing zinc, the oxide semiconductor is easily crystallized in some cases.

Note that the oxide semiconductor 182 is not limited to the oxide semiconductor containing indium. The oxide semiconductor 182 may be an oxide semiconductor that does not contain indium and contains at least one of zinc, gallium, and tin (e.g., a zinc tin oxide or a gallium tin oxide).

For the oxide semiconductor 182, an oxide semiconductor with a wide energy gap is used, for example. The energy gap of the oxide semiconductor 182 is, for example, greater than or equal to 2.5 eV and less than or equal to 4.2 eV, preferably greater than or equal to 2.8 eV and less than or equal to 3.8 eV, more preferably greater than or equal to 3 eV and less than or equal to 3.5 eV.

The oxide semiconductor 182 is preferably a CAAC-OS film which is described later.

The oxide semiconductors 181 and 183 include, for example, one or more, or two or more elements other than oxygen included in the oxide semiconductor 182. Since the oxide semiconductors 181 and 183 include one or more, or two or more elements other than oxygen included in the oxide semiconductor 182, an interface state is less likely to be formed at an interface between the oxide semiconductors 181 and 182 and an interface between the oxide semiconductors 182 and 183.

In the case where the oxide semiconductor 181 or the oxide semiconductor 183 is an In-M-Zn oxide and the total proportion of In and M is assumed to be 100 atomic %, the proportions of In and M are preferably set to be less than 50 atomic % and greater than 50 atomic %, respectively, more preferably less than 25 atomic % and greater than 75 atomic %, respectively. When the oxide semiconductor 181 or the oxide semiconductor 183 is formed by a sputtering method, a sputtering target with the following atomic ratio is preferably used. For example, In:M:Zn is preferably 1:2:4, 1:3:2, 1:3:4, 1:3:6, 1:3:8, 1:4:3, 1:4:4, 1:4:5, 1:4:6, 1:6:3, 1:6:4, 1:6:5, 1:6:6, 1:6:7, 1:6:8, 1:6:9, 1:10:1, 1:5:6, or an atomic ratio which is in the neighborhood of any of the above atomic ratios.

The oxide semiconductor 181 or the oxide semiconductor 183 does not necessarily contain indium in some cases. For example, the oxide semiconductor 181 or the oxide semiconductor 183 may be gallium oxide or an M-Zn oxide. In the case where the M-Zn oxide is formed by a sputtering method, a sputtering target with an atomic ratio of M:Zn=10:1 or an atomic ratio in the neighborhood thereof is preferably used.

In the case of using an In-M-Zn oxide as the oxide semiconductor 182, when the total proportion of In and M is assumed to be 100 atomic %, the proportions of In and M are preferably set to be greater than 25 atomic % and less than 75 atomic %, respectively, more preferably greater than 34 atomic % and less than 66 atomic %, respectively. When the oxide semiconductor 182 is formed by a sputtering method, a sputtering target with the following atomic ratio is preferably used. For example, In:M:Zn is preferably 1:1:1, 1:1:0.5, 1:1:1.2, 2:1:1.5, 2:1:2.3, 2:1:3, 3:1:2, 4:2:4.1, 5:1:7, or an atomic ratio which is in the neighborhood of any of the above atomic ratios.

The function and effect of the oxide semiconductor 180, which includes a stack of the oxide semiconductors 181 to 183, are described with reference to the energy band diagram of FIG. 12B. FIG. 12B shows an energy band structure of a portion taken along dashed line A1-A2 in FIG. 12A.

In FIG. 12B, Ec186, Ec181, Ec182, Ec183, and Ec188 indicate the energies at the bottoms of the conduction bands of the insulator 186, the oxide semiconductor 181, the oxide semiconductor 182, the oxide semiconductor 183, and the insulator 188, respectively.

Here, a difference in energy between the vacuum level and the bottom of the conduction band (the difference is also referred to as electron affinity) corresponds to a value obtained by subtracting an energy gap from a difference in energy between the vacuum level and the top of the valence band (the difference is also referred to as an ionization potential). Note that the energy gap can be measured using a spectroscopic ellipsometer. The energy difference between the vacuum level and the top of the valence band can be measured using an ultraviolet photoelectron spectroscopy (UPS) device.

Since the insulators 186 and 188 are insulators, Ec186 and Ec188 are closer to the vacuum level (i.e., have a lower electron affinity) than Ec181, Ec182, and Ec183.

The oxide semiconductor 182 is an oxide semiconductor having an electron affinity higher than those of the oxide semiconductors 181 and 183. For example, as the oxide semiconductor 182, an oxide semiconductor having an electron affinity higher than those of the oxide semiconductors 181 and 183 by greater than or equal to 0.07 eV and less than or equal to 1.3 eV, preferably greater than or equal to 0.1 eV and less than or equal to 0.7 eV, more preferably greater than or equal to 0.15 eV and less than or equal to 0.4 eV is used. Note that the electron affinity refers to an energy difference between the vacuum level and the bottom of the conduction band.

Indium gallium oxide has a low electron affinity and a high oxygen-blocking property. Therefore, the oxide semiconductor 183 preferably contains indium gallium oxide. The gallium atomic ratio [Ga/(In+Ga)] is, for example, higher than or equal to 70%, preferably higher than or equal to 80%, more preferably higher than or equal to 90%.

At this time, when gate voltage is applied, a channel is formed in the oxide semiconductor 182 having the highest electron affinity among the oxide semiconductors 181 to 183.

At this time, electrons move mainly in the oxide semiconductor 182, not in the oxide semiconductors 181 and 183. Hence, the on-state current of the transistor hardly varies even when the density of interface states, which inhibit electron movement, is high at the interface between the oxide semiconductor 181 and the insulator 186 or at the interface between the oxide semiconductor 183 and the insulator 188. The oxide semiconductors 181 and 183 function as an insulator.

In some cases, there is a mixed region of the oxide semiconductors 181 and 182 between the oxide semiconductors 181 and 182. Furthermore, in some cases, there is a mixed region of the oxide semiconductors 182 and 183 between the oxide semiconductors 182 and 183. Because the mixed region has a low interface state density, a stack of the oxide semiconductors 181 to 183 has a band structure where energy at each interface and in the vicinity of the interface is changed continuously (continuous junction).

As described above, the interface between the oxide semiconductors 181 and 182 or the interface between the oxide semiconductors 182 and 183 has a low interface state density. Hence, electron movement in the oxide semiconductor 182 is less likely to be inhibited and the on-state current of the transistor can be increased.

Electron movement in the transistor is inhibited, for example, in the case where physical surface unevenness in a channel formation region is large. To increase the on-state current of the transistor, for example, the root mean square (RMS) roughness in a measurement area of 1 μm×1 μm of a top surface or a bottom surface of the oxide semiconductor 182 (a formation surface; here, the top surface of the oxide semiconductor 181) is less than 1 nm, preferably less than 0.6 nm, more preferably less than 0.5 nm, still more preferably less than 0.4 nm. The average surface roughness (Ra) in the measurement area of 1 μm×1 μm is less than 1 nm, preferably less than 0.6 nm, more preferably less than 0.5 nm, still more preferably less than 0.4 nm. The maximum peak-to-valley height (P-V) in the measurement area of 1 μm×1 μm is less than 10 nm, preferably less than 9 nm, more preferably less than 8 nm, still more preferably less than 7 nm. The RMS roughness, Ra, and P-V can be measured with, for example, a scanning probe microscope SPA-500 manufactured by SII Nano Technology Inc.

The electron movement is also inhibited in the case where the density of defect states is high in the channel formation region. For example, in the case where the oxide semiconductor 182 contains oxygen vacancies (also denoted by V_{O}), donor levels are formed by entry of hydrogen into sites of oxygen vacancies in some cases. A state in which hydrogen enters sites of oxygen vacancies is denoted by V_{O}H in the following description in some cases. V_{O}H is a factor of decreasing the on-state current of the transistor because V_{O}H scatters electrons. Note that sites of oxygen vacancies become more stable by entry of oxygen than by entry of hydrogen. Thus, by decreasing oxygen vacancies in the oxide semiconductor 182, the on-state current of the transistor can be increased in some cases.

For example, at a certain depth in the oxide semiconductor 182 or in a certain region of the oxide semiconductor 182, the concentration of hydrogen measured by secondary ion mass spectrometry (SIMS) is set to be higher than or equal to 1×10¹⁶ atoms/cm³ and lower than or equal to 2×10²⁰ atoms/cm³, preferably higher than or equal to 1×10¹⁶ atoms/cm³ and lower than or equal to 5×10¹⁹ atoms/cm³, more preferably higher than or equal to 1×10¹⁶ atoms/cm³ and lower than or equal to 1×10¹⁹ atoms/cm³, still more preferably higher than or equal to 1×10¹⁶ atoms/cm³ and lower than or equal to 5×10¹⁸ atoms/cm³.

To decrease oxygen vacancies in the oxide semiconductor 182, for example, there is a method in which excess oxygen contained in the insulator 186 is moved to the oxide semiconductor 182 through the oxide semiconductor 181. In that case, the oxide semiconductor 181 is preferably a layer having oxygen permeability (a layer through which oxygen can pass or permeate).

Note that in the case where the transistor has an s-channel structure, a channel is formed in the entire oxide semiconductor 182. Therefore, as the oxide semiconductor 182 has a larger thickness, a channel region becomes larger. In other words, the thicker the oxide semiconductor 182 is, the higher the on-state current of the transistor is.

Moreover, the thickness of the oxide semiconductor 183 is preferably as small as possible to increase the on-state current of the transistor. For example, the oxide semiconductor 183 has a region with a thickness of less than 10 nm, preferably less than or equal to 5 nm, more preferably less than or equal to 3 nm. Meanwhile, the oxide semiconductor 183 has a function of blocking entry of elements other than oxygen (such as hydrogen and silicon) included in the adjacent insulator into the oxide semiconductor 182 where a channel is formed. Thus, the oxide semiconductor 183 preferably has a certain thickness. For example, the oxide semiconductor 183 may have a region with a thickness of greater than or equal to 0.3 nm, preferably greater than or equal to 1 nm, more preferably greater than or equal to 2 nm. The oxide semiconductor 183 preferably has an oxygen blocking property to inhibit outward diffusion of oxygen released from the insulator 186 and the like.

To improve reliability, preferably, the thickness of the oxide semiconductor 181 is large and the thickness of the oxide semiconductor 183 is small. For example, the oxide semiconductor 181 has a region with a thickness of greater than or equal to 10 nm, preferably greater than or equal to 20 nm, more preferably greater than or equal to 40 nm, still more preferably greater than or equal to 60 nm. An increase in the thickness of the oxide semiconductor 181 can increase the distance from the interface between the adjacent insulator and the oxide semiconductor 181 to the oxide semiconductor 182 where a channel is formed. Note that the oxide semiconductor 181 has a region with a thickness of, for example, less than or equal to 200 nm, preferably less than or equal to 120 nm, more preferably less than or equal to 80 nm, otherwise the productivity of the semiconductor device might be decreased.

For example, a region in which the concentration of silicon is higher than or equal to 1×10¹⁶ atoms/cm³ and lower than 1×10¹⁹ atoms/cm³ is provided between the oxide semiconductors 182 and 181. The concentration of silicon is preferably higher than or equal to 1×10¹⁶ atoms/cm³ and lower than 5×10¹⁸ atoms/cm³, more preferably higher than or equal to 1×10¹⁶ atoms/cm³ and lower than 2×10¹⁸ atoms/cm³. A region in which the concentration of silicon is higher than or equal to 1×10¹⁶ atoms/cm³ and lower than 1×10¹⁹ atoms/cm³ is provided between the oxide semiconductors 182 and 183. The concentration of silicon is preferably higher than or equal to 1×10¹⁶ atoms/cm³ and lower than 5×10¹⁸ atoms/cm³, more preferably higher than or equal to 1×10¹⁶ atoms/cm³ and lower than 2×10¹⁸ atoms/cm³. The concentration of silicon can be measured by SIMS.

It is preferable to reduce the concentration of hydrogen in the oxide semiconductors 181 and 183 in order to reduce the concentration of hydrogen in the oxide semiconductor 182. The oxide semiconductors 181 and 183 each have a region in which the concentration of hydrogen is higher than or equal to 1×10¹⁶ atoms/cm³ and lower than or equal to 2×10²⁰ atoms/cm³. The concentration of hydrogen is preferably higher than or equal to 1×10¹⁶ atoms/cm³ and lower than or equal to 5×10¹⁹ atoms/cm³, more preferably higher than or equal to 1×10¹⁶ atoms/cm³ and lower than or equal to 1×10¹⁹ atoms/cm³, still more preferably higher than or equal to 1×10¹⁶ atoms/cm³ and lower than or equal to 5×10¹⁸ atoms/cm³. The concentration of hydrogen can be measured by SIMS. It is also preferable to reduce the concentration of nitrogen in the oxide semiconductors 181 and 183 in order to reduce the concentration of nitrogen in the oxide semiconductor 182. The oxide semiconductors 181 and 183 each have a region in which the concentration of nitrogen is higher than or equal to 1×10¹⁶ atoms/cm³ and lower than 5×10¹⁹ atoms/cm³. The concentration of nitrogen is preferably higher than or equal to 1×10¹⁶ atoms/cm³ and lower than or equal to 5×10¹⁸ atoms/cm³, more preferably higher than or equal to 1×10¹⁶ atoms/cm³ and lower than or equal to 1×10¹⁸ atoms/cm³, still more preferably higher than or equal to 1×10¹⁶ atoms/cm³ and lower than or equal to 5×10¹⁷ atoms/cm³. The concentration of nitrogen can be measured by SIMS.

The above three-layer structure is an example. For example, a two-layer structure without the oxide semiconductor 181 or 183 may be employed. Alternatively, a four-layer structure may be employed in which one of the semiconductors given as examples of the oxide semiconductors 181 to 183 is provided over or under the oxide semiconductor 181 or over or under the oxide semiconductor 183. Further alternatively, an n-layer structure (n is an integer of 5 or more) may be employed in which one of the semiconductors given as examples of the oxide semiconductors 181 to 183 is provided at two or more of the following positions: over the oxide semiconductor 181, under the oxide semiconductor 181, over the oxide semiconductor 183, and under the oxide semiconductor 183.

### <<Base Insulator>>

Examples of the material of the insulator 184 include aluminum oxide, magnesium oxide, silicon oxide, silicon oxynitride, silicon nitride oxide, silicon nitride, gallium oxide, germanium oxide, yttrium oxide, zirconium oxide, lanthanum oxide, neodymium oxide, hafnium oxide, and tantalum oxide.

The insulator 184 may be formed using silicon oxide with high step coverage which is formed by reacting tetraethyl orthosilicate (TEOS), silane, or the like with oxygen, nitrous oxide, or the like.

The insulator 186 preferably contains an oxide material from which part of oxygen is released by heating. The insulator 186 preferably contains an oxide containing oxygen more than that in the stoichiometric composition. Part of oxygen is released by heating from an oxide film containing oxygen more than that in the stoichiometric composition. Oxygen released from the insulator 186 is supplied to the oxide semiconductor 180, so that oxygen vacancies in the oxide semiconductor 180 can be reduced. Consequently, changes in the electrical characteristics of the transistor can be reduced and the reliability of the transistor can be improved.

The oxide film containing oxygen more than that in the stoichiometric composition is an oxide film of which the amount of released oxygen converted into oxygen atoms is greater than or equal to 1.0×10¹⁸ atoms/cm³, preferably greater than or equal to 3.0×10²⁰ atoms/cm³ in thermal desorption spectroscopy (TDS) analysis. Note that the temperature of the film surface in the TDS analysis is preferably higher than or equal to 100° C. and lower than or equal to 700° C., or higher than or equal to 100° C. and lower than or equal to 500° C.

The insulator 186 preferably contains an oxide that can supply oxygen to the oxide semiconductor 180. For example, for the insulator 186, a material containing silicon oxide or silicon oxynitride is preferably used. Alternatively, a metal oxide such as aluminum oxide, aluminum oxynitride, gallium oxide, gallium oxynitride, yttrium oxide, yttrium oxynitride, hafnium oxide, or hafnium oxynitride may be used for the insulator 186.

To make the insulator 186 contain excess oxygen, the insulator 186 is formed in an oxygen atmosphere, for example. Alternatively, a region containing excess oxygen may be formed by introducing oxygen into the insulator 186 that has been formed. Both the methods may be combined.

For example, oxygen (at least including any of oxygen radicals, oxygen atoms, and oxygen ions) may be introduced into the insulator 186 that has been formed, so that a region containing excess oxygen is formed. Oxygen can be introduced by, for example, an ion implantation method, an ion doping method, a plasma immersion ion implantation method, plasma treatment, or the like.

A gas containing oxygen can be used for oxygen introducing treatment. Examples of the gas containing oxygen include oxygen, nitrous oxide, nitrogen dioxide, carbon dioxide, and carbon monoxide. Furthermore, a rare gas may be included in the gas containing oxygen for the oxygen introducing treatment. Furthermore, hydrogen or the like may be included. For example, a mixed gas of carbon dioxide, hydrogen, and argon may be used.

After the insulator 186 is formed, the insulator 186 may be subjected to planarization treatment using a chemical mechanical polishing (CMP) method or the like to improve the planarity of the top surface thereof.

The insulator 185 has a passivation function of preventing oxygen contained in the insulator 186 from decreasing by bonding to metal contained in the wiring 131.

The insulator 185 has a function of blocking oxygen, hydrogen, water, alkali metal, alkaline earth metal, and the like. Providing the insulator 185 can prevent outward diffusion of oxygen from the oxide semiconductor 180 and entry of hydrogen, water, or the like into the oxide semiconductor 180 from the outside.

The insulator 185 can be, for example, a nitride insulator. Examples of the nitride insulator include silicon nitride, silicon nitride oxide, aluminum nitride, and aluminum nitride oxide. Note that instead of the nitride insulator, an oxide insulator having a blocking effect against oxygen, hydrogen, water, and the like may be provided. Examples of the oxide insulator include aluminum oxide, aluminum oxynitride, gallium oxide, gallium oxynitride, yttrium oxide, yttrium oxynitride, hafnium oxide, and hafnium oxynitride.

The threshold voltage of the transistor M2 can be controlled by injecting electrons into a charge trap layer. The charge trap layer is preferably provided in the insulator 184 or the insulator 185. For example, when the insulator 185 is formed using hafnium oxide, aluminum oxide, tantalum oxide, aluminum silicate, or the like, the insulator 185 can function as a charge trap layer.

### <<Gate Electrode, Source Electrode, and Drain Electrode>>

The conductors 187, 189, and 190 each preferably have a single-layer structure or a layered structure of a conductor containing a low-resistance material selected from copper, tungsten, molybdenum, gold, aluminum, manganese, titanium, tantalum, nickel, chromium, lead, tin, iron, cobalt, ruthenium, platinum, iridium, and strontium, an alloy of such a low-resistance material, or a compound containing such a material as its main component. It is particularly preferable to use a high-melting-point material which has both heat resistance and conductivity, such as tungsten or molybdenum. In addition, the conductor is preferably formed using a low-resistance conductive material such as aluminum or copper. The conductor is more preferably formed using an alloy of copper and manganese, in which case manganese oxide formed at the interface with an insulator containing oxygen has a function of preventing diffusion of copper.

For the conductors 187, 189, and 190, a transparent conductive material containing indium oxide, tin oxide, or zinc oxide can also be used. Examples of the transparent conductive material include indium oxide, indium tin oxide (ITO), indium zinc oxide, zinc oxide, and zinc oxide to which gallium is added.

Alternatively, a stack of any of the above metals and any of the above transparent conductive materials may be used for the conductors 187, 189, and 190.

The oxide semiconductor 182 preferably includes low-resistance regions in contact with the conductor 189 and the conductor 190. When the oxide semiconductor 182 includes the low-resistance regions, contact resistance between the oxide semiconductor 182 and the conductors 189 and 190 can be reduced.

The low-resistance regions are formed when, for example, the conductors 189 and 190 extract oxygen from the oxide semiconductor 182. Oxygen is more likely to be extracted as the heating temperature is higher. Hydrogen enters sites of the oxygen vacancies, increasing the carrier concentration. Thus, the low-resistance regions are formed.

### <Gate Insulator>

The insulator 188 preferably contains an insulator with a high relative dielectric constant. For example, the insulator 188 preferably contains silicon oxide, silicon oxynitride, silicon nitride, silicon nitride oxide, gallium oxide, hafnium oxide, an oxide containing aluminum and hafnium, an oxynitride containing aluminum and hafnium, an oxide containing silicon and hafnium, an oxynitride containing silicon and hafnium, or the like.

The insulator 188 preferably has a layered structure containing silicon oxide or silicon oxynitride and an insulator with a high relative dielectric constant. Because silicon oxide and silicon oxynitride have thermal stability, a combination of silicon oxide or silicon oxynitride with an insulator with a high relative dielectric constant allows the layered structure to be thermally stable and have a high relative dielectric constant. For example, when aluminum oxide, gallium oxide, or hafnium oxide is on the oxide semiconductor 183 side and silicon oxide or silicon oxynitride is on the conductor 187 side, entry of silicon from silicon oxide or silicon oxynitride into the oxide semiconductor 182 can be prevented.

### <Interlayer Insulator and Protective Insulator>

The insulator 191 preferably contains an insulator with a low relative dielectric constant. For example, the insulator 191 preferably contains silicon oxide, silicon oxynitride, silicon nitride oxide, silicon nitride, or a resin. Alternatively, the insulator 191 preferably has a layered structure containing silicon oxide or silicon oxynitride and a resin. Because silicon oxide and silicon oxynitride have thermal stability, combination of silicon oxide or silicon oxynitride with a resin allows the layered structure to be thermally stable and have a low relative dielectric constant. Examples of the resin include polyester, polyolefin, polyamide (e.g., nylon or aramid), polyimide, polycarbonate, and acrylic.

### <Structure Example 2 of Semiconductor Device>

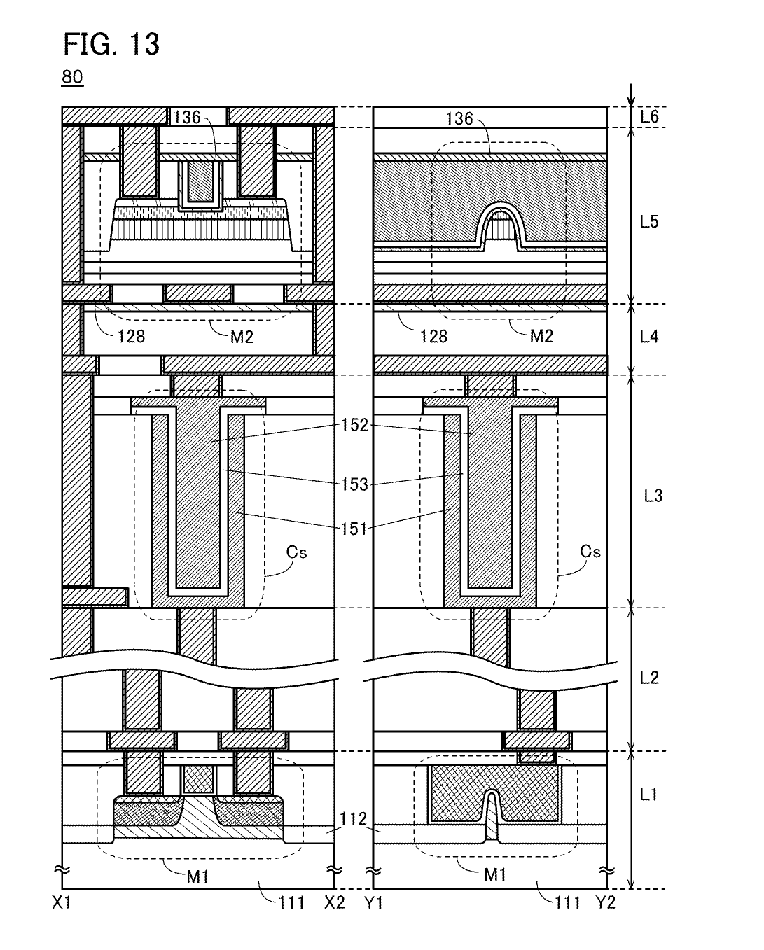

In the IC 80 illustrated in FIG. 8, the capacitor Cs may be provided between the transistor M1 and the transistor M2. A structure example of such a case is illustrated in FIG. 13. Note that the reference numerals of the wirings and the plugs are omitted in FIG. 13.

The transistor M2 is required to have the off-state current lower than that of the transistor M1. Therefore, the transistor M2 is preferably formed after the transistor M1 and the capacitor Cs are formed. When the transistor M2 is formed after other elements are formed, process damage accumulated in the transistor M2 can be reduced. As a result, an increase in the off-state current of the transistor M2 due to the process damage can be prevented.

The position of the capacitor Cs is not limited to the positions illustrated in FIG. 8 and FIG. 13. For example, the capacitor Cs may be provided in the same layer as the transistor M1 or in the same layer as the transistor M2.

In FIG. 8, FIGS. 9A and 9B, FIG. 10, FIGS. 11A and 11B, FIGS. 12A and 12B, and FIG. 13, regions without reference numerals and hatch patterns represent regions formed of an insulator. As the insulator, an insulator containing at least one of aluminum oxide, aluminum nitride oxide, magnesium oxide, silicon oxide, silicon oxynitride, silicon nitride oxide, silicon nitride, gallium oxide, germanium oxide, yttrium oxide, zirconium oxide, lanthanum oxide, neodymium oxide, hafnium oxide, tantalum oxide, and the like can be used. Alternatively, in the regions, an organic resin such as a polyimide resin, a polyamide resin, an acrylic resin, a siloxane resin, an epoxy resin, and a phenol resin can be used.

### Embodiment 3

In this embodiment, a structure example of a display panel applicable to the display 5 illustrated in FIG. 7 will be described with reference to FIGS. 14A, 14B-1, and 14B-2, FIGS. 15A, 15B and 15C, FIG. 16, and FIGS. 17A, 17B-1, and 17B-2.

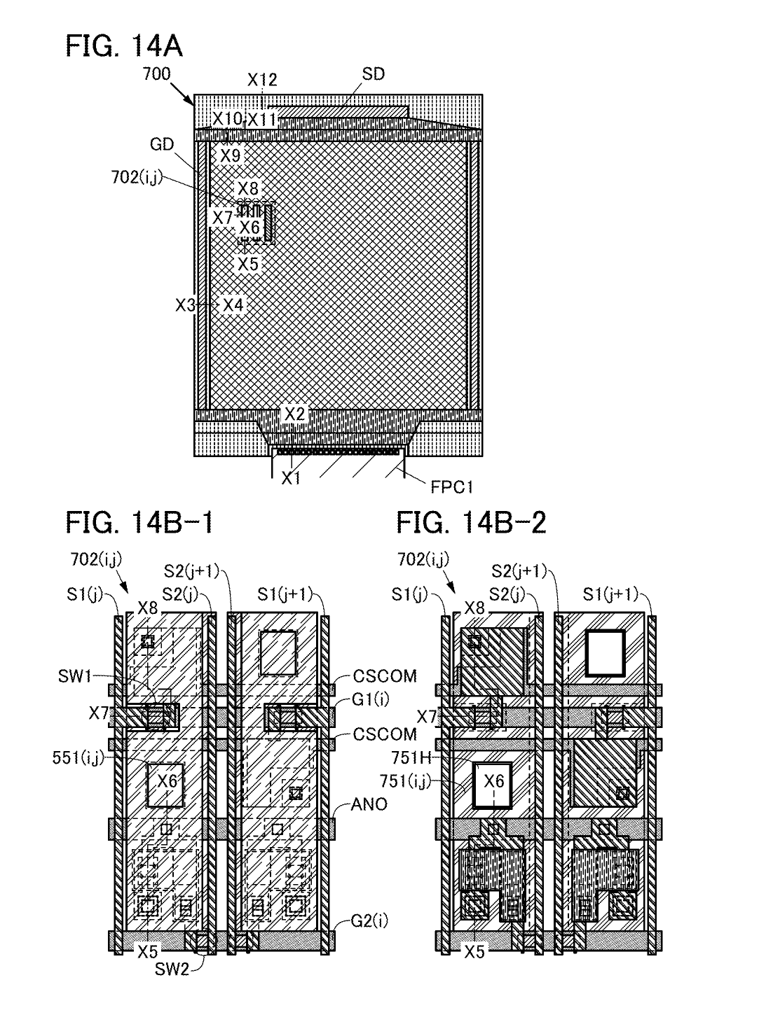

FIGS. 14A, 14B-1, and 14B-2 illustrate a structure of a display panel 700. FIG. 14A is a bottom view of the display panel 700. FIG. 14B-1 is a bottom view illustrating part of FIG. 14A, and FIG. 14B-2 is a bottom view in which some components illustrated in FIG. 14B-1 are omitted.

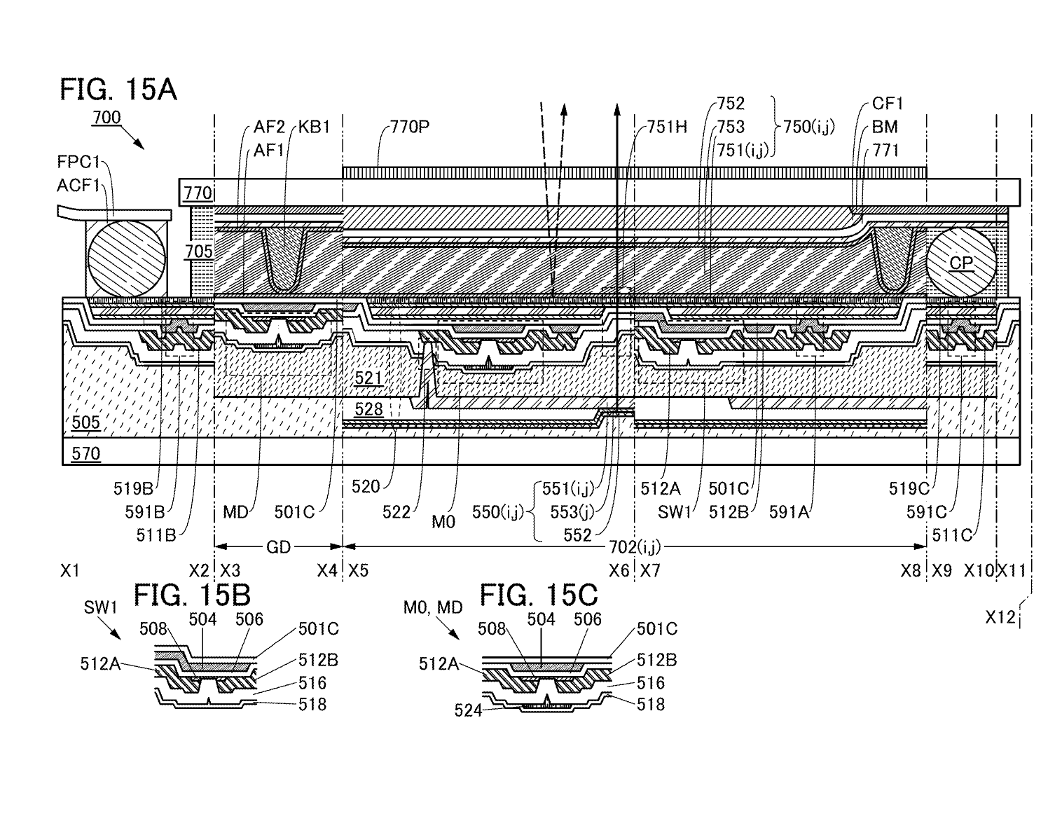

FIGS. 15A to 15C illustrate the structure of the display panel 700. FIG. 15A is a cross-sectional view taken along lines X1-X2, X3-X4, X5-X6, X7-X8, X9-X10, and X11-X12 in FIG. 14A. FIG. 15B is a cross-sectional view illustrating a structure of part of the display panel and FIG. 15C is a cross-sectional view illustrating a structure of another part thereof.

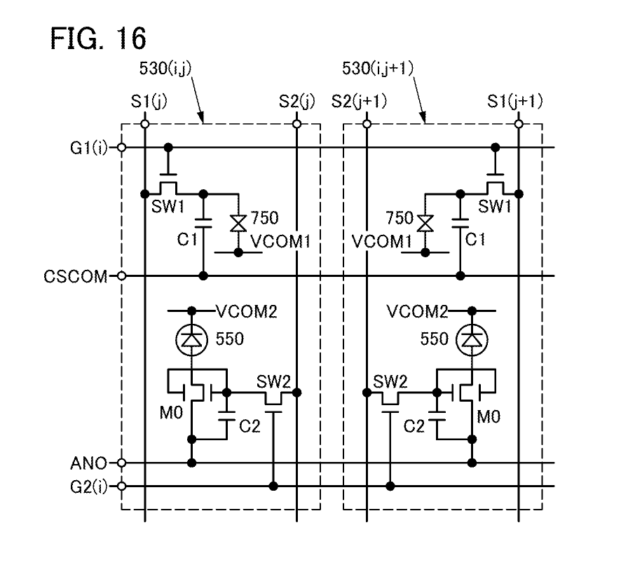

FIG. 16 illustrates the structure of the display panel 700. FIG. 16 is a circuit diagram of a pixel circuit 530(i,j) and a pixel circuit 530(i,j+1) which can be used for pixel circuits included in the display panel 700.

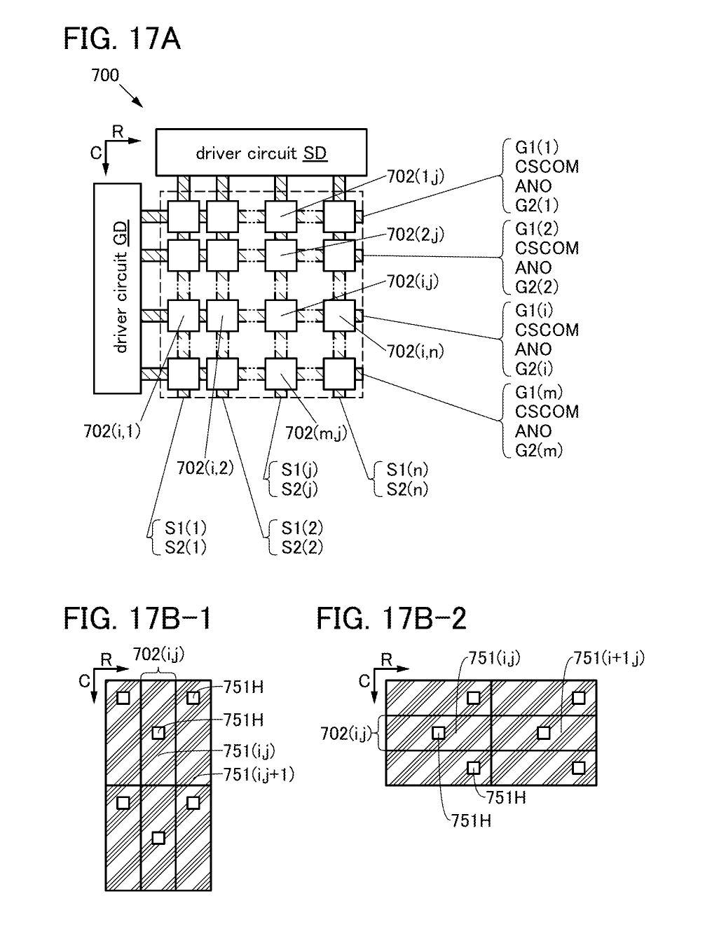

FIGS. 17A, 17B-1, and 17B-2 illustrate the structure of the display panel 700. FIG. 17A is a block diagram illustrating arrangement of pixels, wirings, and the like which can be used for the display panel 700. FIGS. 17B-1 and 17B-2 are schematic views each illustrating arrangement of openings 751H which can be provided in the display panel 700.

### <Structure Example 1 of Display Panel>

The display panel 700 described in this embodiment includes a signal line 51(j) and a pixel 702(i,j) (see FIGS. 14B-1 and 14B-2).

The pixel 702(i,j) is electrically connected to the signal line S1(j).

The pixel 702(i,j) includes a first display element 750(i,j), a first conductive film, a second conductive film, a second insulating film 501C, a pixel circuit 530(i,j), and a second display element 550(i,j) (see FIG. 15A and FIG. 16).

The first conductive film is electrically connected to the first display element 750(i,j) (see FIG. 15A). For example, the first conductive film can be used for a first electrode 751(i,j) of the first display element 750(i,j).

The second conductive film includes a region overlapping with the first conductive film. For example, the second conductive film can be used for a conductive film 512B serving as a source electrode or a drain electrode of a transistor that can be used for a switch SW1.

The second insulating film 501C includes a region interposed between the second conductive film and the first conductive film.

The pixel circuit 530(i,j) is electrically connected to the second conductive film. For example, a transistor using the second conductive film for the conductive film 512B serving as a source electrode or a drain electrode can be used for the switch SW1 of the pixel circuit 530(i,j) (see FIG. 15A and FIG. 16).

The second display element 550(i,j) is electrically connected to the pixel circuit 530(i,j).

The second insulating film 501C has an opening 591A (see FIG. 15A).

The second conductive film is electrically connected to the first conductive film through the opening 591A. For example, the conductive film 512B is electrically connected to the first electrode 751(i,j) which also serves as the first conductive film.

The pixel circuit 530(i,j) is electrically connected to the signal line S1(j) (see FIG. 16). Note that the conductive film 512A is electrically connected to the signal line S1(j) (see FIG. 15A and FIG. 16).

The first electrode 751(i,j) includes a side end portion embedded in the second insulating film 501C.

The pixel circuit 530(i,j) of the display panel described in this embodiment includes the switch SW1. The switch SW1 includes a transistor that includes an oxide semiconductor.

The first display element 750(i,j) and the second display element 550(i,j) of the display panel described in this embodiment perform display in the same direction. For example, a dashed arrow in the drawing denotes the direction in which the first display element 750(i,j) performs display by controlling the intensity of external light reflection.

In addition, a solid arrow in the drawing denotes the direction in which the second display element 550(i,j) performs display (see FIG. 15A).

Furthermore, the second display element 550(i,j) of the display panel described in this embodiment has a function of displaying images in a region surrounded by a region in which the first display element 750(i,j) displays images (see FIG. 17B-1 or FIG. 17B-2). Note that the first display element 750(i,j) displays images in a region overlapping with the first electrode 751(i,j), and the second display element 550(i,j) displays images in a region overlapping with the opening 751H.

The first display element 750(i,j) of the display panel described in this embodiment includes a reflective film having a function of reflecting incident light and has a function of controlling the intensity of reflected light. The reflective film has the opening 751H. Note that the first conductive film, the first electrode 751(i,j), or the like can be used for the reflective film of the first display element 750(i,j).

The second display element 550(i,j) has a function of emitting light toward the opening 751H.

The display panel described in this embodiment includes the pixel 702(i,j), a group of pixels 702(i,1) to 702(i,n), another group of pixels 702(1,j) to 702(m,j), and a scan line G1(i) (see FIG. 17A). Note that i is an integer greater than or equal to 1 and less than or equal to m, j is an integer greater than or equal to 1 and less than or equal to n, and each of m and n is an integer greater than or equal to 1.

The display panel described in this embodiment also includes a scan line G2(i), a wiring CSCOM, and a wiring ANO.

The group of pixels 702(i,1) to 702(i,n) include the pixel 702(i,j) and are arranged in the row direction (the direction shown by the arrow R in drawings).

The another group of pixels 702(1,j) to 702(m,j) include the pixel 702(i,j) and are arranged in the column direction (the direction shown by the arrow C in drawings) intersecting the row direction.

The scan line G1(i) is electrically connected to the group of pixels 702(i,1) to 702(i,n) arranged in the row direction.

The another group of pixels 702(1,j) to 702(m,j) arranged in the column direction are electrically connected to the signal line S1(j).

For example, the pixel 702(i,j+1) adjacent to the pixel 702(i,j) in the row direction has an opening in a position different from that of the opening 751H in the pixel 702(i,j) (see FIG. 17B-1).

For example, the pixel 702(i+1,j) adjacent to the pixel 702(i,j) in the column direction has an opening in a position different from that of the opening 751H in the pixel 702(i,j) (see FIG. 17B-2). Note that for example, the first electrode 751(i,j) can be used for the reflective film.

The above-described display panel includes the first display element, the first conductive film electrically connected to the first display element, the second conductive film including a region overlapping with the first conductive film, the insulating film including a region between the second conductive film and the first conductive film, the pixel circuit electrically connected to the second conductive film, and the second display element electrically connected to the pixel circuit. The second insulating film includes the opening and the second conductive film and the first conductive film are electrically connected to each other through the opening.

Thus, the first display element and the second display element that displays an image using a method different from that of the first display element can be driven using pixel circuits that can be formed in the same process. Thus, the novel display panel can be highly convenient or reliable.

The display panel described in this embodiment also includes a terminal 519B and a conductive film 511B (see FIG. 15A).

The second insulating film 501C includes a region between the terminal 519B and the conductive film 511B. The second insulating film 501C has an opening 591B.

The terminal 519B is electrically connected to the conductive film 511B in the opening 591B. In addition, the conductive film 511B is electrically connected to the pixel circuit 530(i,j). For example, in the case where the first electrode 751(i,j) or the first conductive film is used for the reflective film, a surface serving as a contact of the terminal 519B faces in the same direction as a surface of the first electrode 751(i,j) which faces light incident on the first display element 750(i,j).

Thus, power or signals can be supplied to the pixel circuit through the terminal. Thus, the novel display panel can be highly convenient or reliable.

The first display element 750(i,j) of the display panel described in this embodiment includes a layer 753 containing a liquid crystal material, the first electrode 751(i,j), and a second electrode 752. The second electrode 752 is positioned such that an electric field which controls the alignment of the liquid crystal material is generated between the second electrode 752 and the first electrode 751(i,j).

The display panel described in this embodiment also includes an alignment film AF1 and an alignment film AF2. The alignment film AF2 is provided such that the layer 753 containing a liquid crystal material is interposed between the alignment film AF1 and the alignment film AF2.

The second display element 550(i,j) of the display panel described in this embodiment includes a third electrode 551(i,j), a fourth electrode 552, and a layer 553(j) containing a light-emitting organic compound.

The fourth electrode 552 includes a region overlapping with the third electrode 551(i,j). The layer 553(j) containing a light-emitting organic compound is provided between the third electrode 551 and the fourth electrode 552. The third electrode 551(i,j) is electrically connected to the pixel circuit 530(i,j) at a connection portion 522.

The pixel 702(i,j) of the display panel described in this embodiment includes a coloring film CF1, a light-blocking film BM, an insulating film 771, and a functional film 770P.

The coloring film CF1 includes a region overlapping with the first display element 750(i,j). The light-blocking film BM has an opening in a region overlapping with the first display element 750(i,j).

The insulating film 771 is provided between the coloring film CF1 and the layer 753 containing a liquid crystal material or between the light-blocking film BM and the layer 753 containing a liquid crystal material. The insulating film 771 can reduce unevenness due to the thickness of the coloring film CF1. Furthermore, the insulating film 771 can prevent impurities from diffusing from the light-blocking film BM, the coloring film CF1, or the like to the layer 753 containing a liquid crystal material.

The functional film 770P includes a region overlapping with the first display element 750(i,j). The functional film 770P is provided such that a substrate 770 is interposed between the functional film 770P and the first display element 750(i,j).

The display panel described in this embodiment includes a substrate 570, the substrate 770, and a functional layer 520.

The substrate 770 includes a region overlapping with the substrate 570. The functional layer 520 is provided between the substrate 570 and the substrate 770.

The functional layer 520 includes the pixel circuit 530(i,j), the second display element 550(i,j), an insulating film 521, and an insulating film 528. The functional layer 520 includes an insulating film 518 and an insulating film 516.

The insulating film 521 is provided between the pixel circuit 530(i,j) and the second display element 550(i,j).

The insulating film 528 is provided between the insulating film 521 and the substrate 570, and has an opening in a region overlapping with the second display element 550(i,j). The insulating film 528 formed along the outer edge of the third electrode 551 can prevent a short circuit between the third electrode 551 and the fourth electrode 552.

The insulating film 518 includes a region interposed between the insulating film 521 and the pixel circuit 530(i,j), and the insulating film 516 includes a region interposed between the insulating film 518 and the pixel circuit 530(i,j).

The display panel described in this embodiment also includes a bonding layer 505, a sealing material 705, and a structure body KB1.

The bonding layer 505 is provided between the functional layer 520 and the substrate 570, and has a function of bonding the functional layer 520 and the substrate 570 together. The sealing material 705 is provided between the functional layer 520 and the substrate 770, and has a function of bonding the functional layer 520 and the substrate 770 together.

The structure body KB1 has a function of providing a certain space between the functional layer 520 and the substrate 770.

The display panel described in this embodiment also includes a terminal 519C, a conductive film 511C, and a conductor CP.

The second insulating film 501C includes a region interposed between the terminal 519C and the conductive film 511C. The second insulating film 501C has an opening 591C.

The terminal 519C is electrically connected to the conductive film 511C through the opening 591C. The conductive film 511C is electrically connected to the pixel circuit 530(i,j).

The conductor CP is interposed between the terminal 519C and the second electrode 752, and electrically connects the terminal 519C and the second electrode 752. For example, a conductive particle can be used as the conductor CP.

The display panel described in this embodiment also includes a driver circuit GD and a driver circuit SD (see FIG. 14A and FIG. 17A).

The driver circuit GD is electrically connected to the scan line G1(i). The driver circuit GD includes a transistor MD, for example. Specifically, a transistor including a semiconductor film that can be formed in the same process as the transistor included in the pixel circuit 530(i,j) can be used as the transistor MD (see FIGS. 15A and 15C).

The driver circuit SD is electrically connected to the signal line S1(j). The driver circuit SD is electrically connected to a terminal that can be formed in the same process as, for example, the terminal 519B or the terminal 519C with the use of a conductive material.

Individual components included in the display panel will be described below. Note that these components cannot be clearly distinguished and one component also serves as another component or may include part of another component.

For example, the first conductive film can be used for the first electrode 751(i,j). Furthermore, the first conductive film can also be used for the reflective film.

The second conductive film can be used for the conductive film 512B serving as the source electrode or the drain electrode of the transistor.

### <<Structure Example 1>>

The display panel includes the substrate 570, the substrate 770, the structure body KB1, the sealing material 705, or the bonding layer 505.

The display panel also includes the functional layer 520, the insulating film 521, or the insulating film 528.

The display panel also includes the signal line S1(j), a signal line S2(j), the scan line G1(i), the scan line G2(i), the wiring CSCOM, or the wiring ANO.

The display panel also includes the first conductive film or the second conductive film.

The display panel also includes the terminal 519B, the terminal 519C, the conductive film 511B, or the conductive film 511C.

The display panel also includes the pixel circuit 530(i,j) or the switch SW1.

The display panel also includes the first display element 750(i,j), the first electrode 751(i,j), the reflective film, the opening 751H, the layer 753 containing a liquid crystal material, or the second electrode 752.

The display panel also includes the alignment film AF1, the alignment film AF2, the coloring film CF1, the light-blocking film BM, the insulating film 771, or the functional film 770P.

The display panel also includes the second display element 550(i,j), the third electrode 551(i,j), the fourth electrode 552, or the layer 553(j) containing a light-emitting organic compound.

The display panel includes the second insulating film 501C.

The display panel also includes the driver circuit GD or the driver circuit SD.

### <<Substrate 570>>

The substrate 570 or the like can be formed using a material having heat resistance high enough to withstand heat treatment in the manufacturing process. Specifically, non-alkali glass with a thickness of 0.7 mm can be used.

For example, a large-sized glass substrate having any of the following sizes can be used as the substrate 570 or the like: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

For the substrate 570 or the like, an organic material, an inorganic material, a composite material of an organic material and an inorganic material, or the like can be used. For example, an inorganic material such as glass, ceramic, or metal can be used for the substrate 570 or the like.

Specifically, non-alkali glass, soda-lime glass, potash glass, crystal glass, quartz, sapphire, or the like can be used for the substrate 570 or the like. Specifically, an inorganic oxide film, an inorganic nitride film, an inorganic oxynitride film, or the like can be used for the substrate 570 or the like. For example, silicon oxide, silicon nitride, silicon oxynitride, an alumina film, or the like can be used for the substrate 570 or the like. For example, stainless steel (SUS) or aluminum can be used for the substrate 570 or the like.

For example, a single crystal semiconductor substrate or a polycrystalline semiconductor substrate of silicon or silicon carbide, a compound semiconductor substrate of silicon germanium or the like, or an SOI substrate can be used as the substrate 570 or the like. Thus, a semiconductor element can be provided over the substrate 570 or the like.

For example, an organic material such as a resin, a resin film, or plastic can be used for the substrate 570 or the like. Specifically, a resin film or a resin plate of polyester, polyolefin, polyamide, polyimide, polycarbonate, an acrylic resin, or the like can be used for the substrate 570 or the like.

For example, a composite material formed by attaching a metal plate, a thin glass plate, or a film of an inorganic material to a resin film or the like can be used for the substrate 570 or the like. For example, a composite material formed by dispersing a fibrous or particulate metal, glass, inorganic material, or the like into a resin film can be used for the substrate 570 or the like. For example, a composite material formed by dispersing a fibrous or particulate resin, organic material, or the like into an inorganic material can be used for the substrate 570 or the like.

Furthermore, a single-layer material or a layered material in which a plurality of layers are stacked can be used for the substrate 570 or the like. For example, a layered material in which a base, an insulating film that prevents diffusion of impurities contained in the base, and the like are stacked can be used for the substrate 570 or the like. Specifically, a layered material in which glass and one or a plurality of films that are selected from a silicon oxide layer, a silicon nitride layer, a silicon oxynitride layer, and the like and that prevent diffusion of impurities contained in the glass are stacked can be used for the substrate 570 or the like. Alternatively, a layered material in which a resin and a film for preventing diffusion of impurities that penetrate the resin, such as a silicon oxide film, a silicon nitride film, and a silicon oxynitride film are stacked can be used for the substrate 570 or the like.

Specifically, a resin film, a resin plate, a stack, or the like of polyester, polyolefin, polyamide, polyimide, polycarbonate, an acrylic resin, or the like can be used for the substrate 570 or the like.

Specifically, a material including polyester, polyolefin, polyamide (e.g., nylon or aramid), polyimide, polycarbonate, polyurethane, an acrylic resin, an epoxy resin, or a resin having a siloxane bond, such as silicone, can be used for the substrate 570 or the like.

Specifically, polyethylene terephthalate (PET), polyethylene naphthalate (PEN), polyethersulfone (PES), acrylic, or the like can be used for the substrate 570 or the like.

Alternatively, paper, wood, or the like can be used for the substrate 570 or the like.

For example, a flexible substrate can be used as the substrate 570 or the like.

Note that a transistor, a capacitor, or the like can be directly formed on the substrate. Alternatively, a transistor, a capacitor, or the like formed on a substrate for use in manufacturing processes which can withstand heat applied in the manufacturing process can be transferred to the substrate 570 or the like. Thus, a transistor, a capacitor, or the like can be formed over a flexible substrate, for example.

### <<Substrate 770>>

For example, a light-transmitting material can be used for the substrate 770. Specifically, any of the materials that can be used for the substrate 570 can be used for the substrate 770. Specifically, non-alkali glass polished to a thickness of approximately 0.7 mm or 0.1 mm can be used.

### <<Structure Body KB1>>

The structure body KB1 or the like can be formed using an organic material, an inorganic material, or a composite material of an organic material and an inorganic material. This allows a predetermined space to be provided between components between which the structure body KB1 or the like is interposed.

Specifically, for the structure body KB1 or the like, polyester, polyolefin, polyamide, polyimide, polycarbonate, polysiloxane, an acrylic resin, or the like, or a composite material of a plurality of kinds of resins selected from these can be used. Alternatively, a photosensitive material may be used.

### <<Sealing Material 705>>

For the sealing material 705 or the like, an inorganic material, an organic material, a composite material of an inorganic material and an organic material, or the like can be used.

For example, an organic material such as a thermally fusible resin or a curable resin can be used for the sealing material 705 or the like.

For example, an organic material such as a reactive curable adhesive, a light curable adhesive, a thermosetting adhesive, and/or an anaerobic adhesive can be used for the sealing material 705 or the like.

Specifically, an adhesive containing an epoxy resin, an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, or the like can be used for the sealing material 705 or the like.

### <<Bonding Layer 505>>

For example, any of the materials that can be used for the sealing material 705 can be used for the bonding layer 505.

### <<Insulating Film 521>>

For example, an insulating inorganic material, an insulating organic material, or an insulating composite material containing an inorganic material and an organic material can be used for the insulating film 521 or the like.

Specifically, an inorganic oxide film, an inorganic nitride film, an inorganic oxynitride film, or a material obtained by stacking any of these films and the like can be used as the insulating film 521 or the like. For example, a film including any of a silicon oxide film, a silicon nitride film, a silicon oxynitride film, an aluminum oxide film, and the like, or a film including a material obtained by stacking any of these films can be used as the insulating film 521 or the like.

Specifically, for the insulating film 521 or the like, polyester, polyolefin, polyamide, polyimide, polycarbonate, polysiloxane, an acrylic resin, or the like, or a layered or composite material of a plurality of kinds of resins selected from these can be used. Alternatively, a photosensitive material may be used.

Thus, steps due to various components overlapping with the insulating film 521, for example, can be reduced.

### <<Insulating Film 528>>

For example, any of the materials that can be used for the insulating film 521 can be used for the insulating film 528 or the like. Specifically, a 1-μm-thick polyimide-containing film can be used as the insulating film 528.

### <<Second Insulating Film 501C>>

For example, any of the materials that can be used for the insulating film 521 can be used for the second insulating film 501C. Specifically, a material containing silicon and oxygen can be used for the second insulating film 501C. Thus, diffusion of impurities into the pixel circuit, the second display element, or the like can be inhibited.

For example, a 200-nm-thick film containing silicon, oxygen, and nitrogen can be used as the second insulating film 501C.

Note that the second insulating film 501C has the opening 591A, the opening 591B, and the opening 591C.

### <<Wiring, Terminal, and Conductive Film>>

A conductive material can be used for the wiring or the like. Specifically, a conductive material can be used for the signal line S1(j), the signal line S2(j), the scan line G1(i), the scan line G2(i), the wiring CSCOM, the wiring ANO, the terminal 519B, the terminal 519C, the conductive film 511B, the conductive film 511C, or the like.

For example, an inorganic conductive material, an organic conductive material, a metal, conductive ceramics, or the like can be used for the wiring or the like.

Specifically, a metal element selected from aluminum, gold, platinum, silver, copper, chromium, tantalum, titanium, molybdenum, tungsten, nickel, iron, cobalt, palladium, and manganese can be used for the wiring or the like. Alternatively, an alloy including any of the above-described metal elements, or the like can be used for the wiring or the like. In particular, an alloy of copper and manganese is preferably used in microfabrication using a wet etching method.

Specifically, any of the following structures can be used for the wiring or the like: a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like.

Specifically, a conductive oxide, such as indium oxide, indium tin oxide, indium zinc oxide, zinc oxide, or zinc oxide to which gallium is added, can be used for the wiring or the like.

Specifically, a film containing graphene or graphite can be used for the wiring or the like.

For example, a film containing graphene formed by reducing a film containing graphene oxide can be used. The reduction can be performed by applying heat, using a reducing agent, or the like.

Specifically, a conductive high molecular can be used for the wiring or the like.

### <<First Conductive Film and Second Conductive Film>>

For example, any of the materials that can be used for the wiring or the like can be used for the first conductive film or the second conductive film.

Alternatively, a first electrode 751(i,j), the wiring, or the like can be used for the first conductive film.

The wiring, the conductive film 512B of the transistor that can be used for the switch SW1, or the like can be used for the second conductive film.

<<Pixel Circuit 530(i,j)>>

The pixel circuit 530(i,j) is electrically connected to the signal line S1(j), the signal line S2(j), the scan line G1(i), the scan line G2(i), the wiring CSCOM, and the wiring ANO (see FIG. 16).

The pixel circuit 530(i,j+1) is electrically connected to a signal line S1(j+1), a signal line 52(j+1), the scan line G1(i), the scan line G2(i), the wiring CSCOM, and the wiring ANO.

In the case where the voltage of a signal supplied to the signal line 52(j) is different from the voltage of a signal supplied to the signal line S1(j+1), the signal line S1(j+1) is positioned apart from the signal line S2(j). Specifically, the signal line S2(j+1) is positioned adjacent to the signal line S2(j).

The pixel circuit 530(i,j) includes the switch SW1, a capacitor C1, a switch SW2, a transistor M0, and a capacitor C2.

For example, a transistor including a gate electrode electrically connected to the scan line G1(i) and a first electrode electrically connected to the signal line S1(j) can be used for the switch SW1.

The capacitor C1 includes a first electrode electrically connected to a second electrode of the transistor used for the switch SW1 and a second electrode electrically connected to the wiring CSCOM.

For example, a transistor including a gate electrode electrically connected to the scan line G2(i) and a first electrode electrically connected to the signal line S2(j) can be used for the switch SW2.

The transistor M0 includes a gate electrode electrically connected to a second electrode of the transistor used for the switch SW2 and a first electrode electrically connected to the wiring ANO.

Note that a transistor including a conductive film provided such that a semiconductor film is interposed between a gate electrode and the conductive film can be used as the transistor M0. For example, a conductive film electrically connected to the wiring capable of supplying a potential equal to that supplied to the first electrode of the transistor M0 can be used.

The capacitor C2 includes a first electrode electrically connected to the second electrode of the transistor used for the switch SW2 and a second electrode electrically connected to the first electrode of the transistor M0.

Note that a first electrode and a second electrode of the first display element 750 are electrically connected to the second electrode of the transistor used for the switch SW1 and a wiring VCOM1, respectively. This enables the first display element 750 to be driven.

Note that a first electrode and a second electrode of the second display element 550 are electrically connected to the second electrode of the transistor M0 and a wiring VCOM2, respectively. This enables the second display element 550 to be driven.

The switch SW1, the switch SW2, and the transistor M0 included in the pixel circuit 530(i,j) are preferably formed in the same step. Thus, manufacturing cost of the display panel 700 can be greatly reduced.

### <<Switch SW1, Switch SW2, Transistor M0, and Transistor MD>>

For example, a bottom-gate or top-gate transistor can be used for the switch SW1, the switch SW2, the transistor M0, the transistor MD, and the like.

For example, a transistor including a semiconductor containing an element belonging to Group 14 in a semiconductor film can be used. Specifically, a semiconductor containing silicon can be used for a semiconductor film. For example, single crystal silicon, polysilicon, microcrystalline silicon, amorphous silicon, or the like can be used for the semiconductor films of the transistors.

For example, a transistor using an oxide semiconductor for a semiconductor film can be used. Specifically, an oxide semiconductor containing indium or an oxide semiconductor containing indium, gallium, and zinc can be used for a semiconductor film.

For example, a transistor having a lower leakage current in an off state than a transistor that uses amorphous silicon for a semiconductor film can be used for the switch SW1, the switch SW2, the transistor M0, the transistor MD, and the like. Specifically, a transistor using an oxide semiconductor for a semiconductor film 508 can be used for the switch SW1, the switch SW2, the transistor M0, the transistor MD, and the like.

Thus, a pixel circuit can hold an image signal for a longer time than a pixel circuit including a transistor that uses amorphous silicon for a semiconductor film. Specifically, the selection signal can be supplied at a frequency of lower than 30 Hz, preferably lower than 1 Hz, more preferably less than once per minute while flickering is suppressed. Consequently, eyestrain on a user of a data processing device can be reduced, and power consumption for driving can be reduced.

The transistor that can be used for the switch SW1 includes the semiconductor film 508 and a conductive film 504 including a region overlapping with the semiconductor film 508 (see FIG. 15B). The transistor that can be used for the switch SW1 also includes the conductive film 512A and the conductive film 512B.

Note that the conductive film 504 and the insulating film 506 serve as a gate electrode and a gate insulating film, respectively. The conductive film 512A has one of a function of a source electrode and a function of a drain electrode, and the conductive film 512B has the other.

A transistor including a conductive film 524 provided such that the semiconductor film 508 is interposed between the conductive film 504 and the conductive film 524 can be used as the transistor M0 (see FIG. 15C).

A conductive film formed by stacking a 10-nm-thick film containing tantalum and nitrogen and a 300-nm-thick film containing copper in this order can be used as the conductive film 504.

A material obtained by stacking a 400-nm-thick film containing silicon and nitrogen and a 200-nm-thick film containing silicon, oxygen, and nitrogen can be used for the insulating film 506.

A 25-nm-thick film containing indium, gallium, and zinc can be used as the semiconductor film 508.

A conductive film formed by stacking a 50-nm-thick film containing tungsten, a 400-nm-thick film containing aluminum, and a 100-nm-thick film containing titanium in this order can be used as the conductive film 512A or the conductive film 512B.

<<First Display Element 750(i,j)>>

For example, a display element having a function of controlling transmission or reflection of light can be used as the first display element 750(i,j) or the like. For example, a combined structure of a polarizing plate and a liquid crystal element or a MEMS shutter display element can be used. The use of a reflective display element can reduce power consumption of a display panel. Specifically, a reflective liquid crystal display element can be used as the first display element 750.

Specifically, a liquid crystal element that can be driven by any of the following driving methods can be used: an in-plane switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like.

In addition, a liquid crystal element that can be driven by, for example, a vertical alignment (VA) mode such as a multi-domain vertical alignment (MVA) mode, a patterned vertical alignment (PVA) mode, an electrically controlled birefringence (ECB) mode, a continuous pinwheel alignment (CPA) mode, or an advanced super view (ASV) mode can be used.

For example, thermotropic liquid crystal, low-molecular liquid crystal, high-molecular liquid crystal, polymer dispersed liquid crystal, ferroelectric liquid crystal, or anti-ferroelectric liquid crystal can be used. Alternatively, a liquid crystal material which exhibits a cholesteric phase, a smectic phase, a cubic phase, a chiral nematic phase, an isotropic phase, or the like can be used. Alternatively, a liquid crystal material which exhibits a blue phase can be used.

<<First Electrode 751(i,j)>>

For example, the material that is used for the wiring or the like can be used for the first electrode 751(i,j). Specifically, a reflective film can be used for the first electrode 751(i,j).

### <<Reflective Film>>

For example, a material that reflects visible light can be used for the reflective film. Specifically, a material containing silver can be used for the reflective film. For example, a material containing silver, palladium, and the like or a material containing silver, copper, and the like can be used for the reflective film.

The reflective film reflects light that passes through the layer 753 containing a liquid crystal material, for example. This allows the first display element 750 to serve as a reflective liquid crystal element. Alternatively, for example, a material with unevenness on its surface can be used for the reflective film. In that case, incident light can be reflected in various directions so that a white image can be displayed.

Note that the first electrode 751(i,j) is not necessarily used for the reflective film. For example, the reflective film can be provided between the layer 753 containing a liquid crystal material and the first electrode 751(i,j). Alternatively, the first electrode 751(i,j) having a light-transmitting property can be provided between the reflective film and the layer 753 containing a liquid crystal material.

### <<Opening 751H>>

If the ratio of the total area of the opening 751H to the total area of the reflective film other than the opening is excessively high, an image displayed using the first display element 750(i,j) is dark. If the ratio of the total area of the opening 751H to the total area of the reflective film other than the opening is excessively low, an image displayed using the second display element 550(i,j) is dark.

If the area of the opening 751H in the reflective film is too small, light emitted from the second display element 550 is not efficiently extracted for display.

The opening 751H may have a polygonal shape, a quadrangular shape, an elliptical shape, a circular shape, a cross shape, a stripe shape, a slit-like shape, or a checkered pattern. The opening 751H may be close to the adjacent pixel. The opening 751H is preferably provided close to a pixel that has a function of emitting light of the same color. The arrangement prevents crosstalk, which is the phenomenon in which light emitted from the second display element 550 enters a coloring film of the adjacent pixel.

### <<Second Electrode 752>>

For example, a material having a visible-light-transmitting property and conductivity can be used for the second electrode 752.

For example, a conductive oxide, a metal film thin enough to transmit light, or a metal nanowire can be used for the second electrode 752.

Specifically, a conductive oxide containing indium can be used for the second electrode 752. Alternatively, a metal thin film with a thickness greater than or equal to 1 nm and less than or equal to 10 nm can be used for the second electrode 752. Alternatively, a metal nanowire containing silver can be used for the second electrode 752.

Specifically, indium oxide, indium tin oxide, indium zinc oxide, zinc oxide, zinc oxide to which gallium is added, zinc oxide to which aluminum is added, or the like can be used for the second electrode 752.

### <<Alignment Films AF1 and AF2>>

The alignment films AF1 and AF2 can be formed using a material containing polyimide or the like, for example. Specifically, a material formed to have alignment in the predetermined direction by rubbing treatment or an optical alignment technique can be used.

For example, a film containing soluble polyimide can be used for the alignment films AF1 and AF2.

<<Coloring film CF1>>

The coloring film CF1 can be formed using a material transmitting light of a predetermined color, and can thus be used as a color filter or the like.

The coloring film CF1 can be formed using a material transmitting light of blue, green, red, yellow, or white, for example.

### <<Light-Blocking Film BM>>

A material that prevents light transmission can be used for the light-blocking film BM, in which case the light-blocking film BM serves as a black matrix, for example.

### <<Insulating Film 771>>

The insulating film 771 can be formed using polyimide, epoxy resin, acrylic resin, or the like.

### <<Functional Film 770P>>

For example, a polarizing plate, a retardation plate, a diffusing film, an anti-reflective film, a condensing film, or the like can be used as the functional film 770P. Alternatively, a polarizing plate containing a dichromatic pigment can be used for the functional film 770P.

Alternatively, an antistatic film preventing the attachment of a foreign substance, a water repellent film suppressing the attachment of stain, a hard coat film suppressing a scratch in use, or the like can be used as the functional film 770P.

<<Second Display Element 550(i,j)>>

A light-emitting element, for example, can be used as the second display element 550(i,j). Specifically, an organic electroluminescence (organic EL) element, an inorganic electroluminescence (organic EL) element, a light-emitting diode, or the like can be used for the second display element 550(i,j).

For example, a stack formed so as to emit blue, green, or red light, or the like can be used for the layer 553(j) containing a light-emitting organic compound.

For example, a belt-like stack that extends in the column direction along the signal line S1(j) can be used for the layer 553(j) containing a light-emitting organic compound. Furthermore, a belt-like stack that extends in the column direction along the signal line S1(j+1) and emits light of a color different from that of light emitted from the layer 553(j) containing a light-emitting organic compound can be used for a layer 553(j+1) containing a light-emitting organic compound.

For example, a stack formed so as to emit white light can be used for the layer 553(j) containing a light-emitting organic compound and the layer 553(j+1) containing a light-emitting organic compound. Specifically, a stack of a layer containing a light-emitting organic compound including a fluorescent material that emits blue light, and a layer containing a material that is other than a fluorescent material and that emits green light and/or red light or a layer containing a material that is other than a fluorescent material and that emits yellow light can be used for the layer 553(j) containing a light-emitting organic compound and the layer 553(j+1) containing a light-emitting organic compound.

For example, any of the materials that can be used for the wiring or the like can be used for the third electrode 551(i,j) or the fourth electrode 552.

For example, a material that transmits visible light among the materials that can be used for the wiring or the like can be used for the third electrode 551(i,j).

Specifically, conductive oxide, indium-containing conductive oxide, indium oxide, indium tin oxide, indium zinc oxide, zinc oxide, zinc oxide to which gallium is added, or the like can be used for the third electrode 551(i,j). Alternatively, a metal film that is thin enough to transmit light can be used as the third electrode 551(i,j).

For example, a material that reflects visible light among the materials that can be used for the wiring or the like can be used for the fourth electrode 552.

### <<Driver Circuit GD>>

Any of a variety of sequential circuits such as a shift register can be used as the driver circuit GD. For example, the transistor MD, a capacitor, and the like can be used in the driver circuit GD. Specifically, a transistor including a semiconductor film that can be formed in the same step as the transistor M0 can be used.

As the transistor MD, a transistor different from the transistor that can be used for the switch SW1 can be used. Specifically, a transistor including the conductive film 524 can be used for the transistor MD (see FIG. 15C).

The semiconductor film 508 is provided between the conductive films 524 and 504. The insulating film 516 is provided between the conductive film 524 and the semiconductor film 508. The insulating film 506 is provided between the semiconductor film 508 and the conductive film 504. For example, the conductive film 524 is electrically connected to a wiring that supplies a potential equal to that supplied to the conductive film 504.

Note that the transistor MD can have the same structure as the transistor M0.

### <<Driver Circuit SD>>

For example, an integrated circuit can be used as the driver circuit SD. Specifically, an integrated circuit formed over a silicon substrate can be used as the driver circuit SD.

For example, a chip on glass (COG) method can be used to mount the driver circuit SD on a pad electrically connected to the pixel circuit 530(i,j). Specifically, an anisotropic conductive film can be used to mount the integrated circuit on the pad.

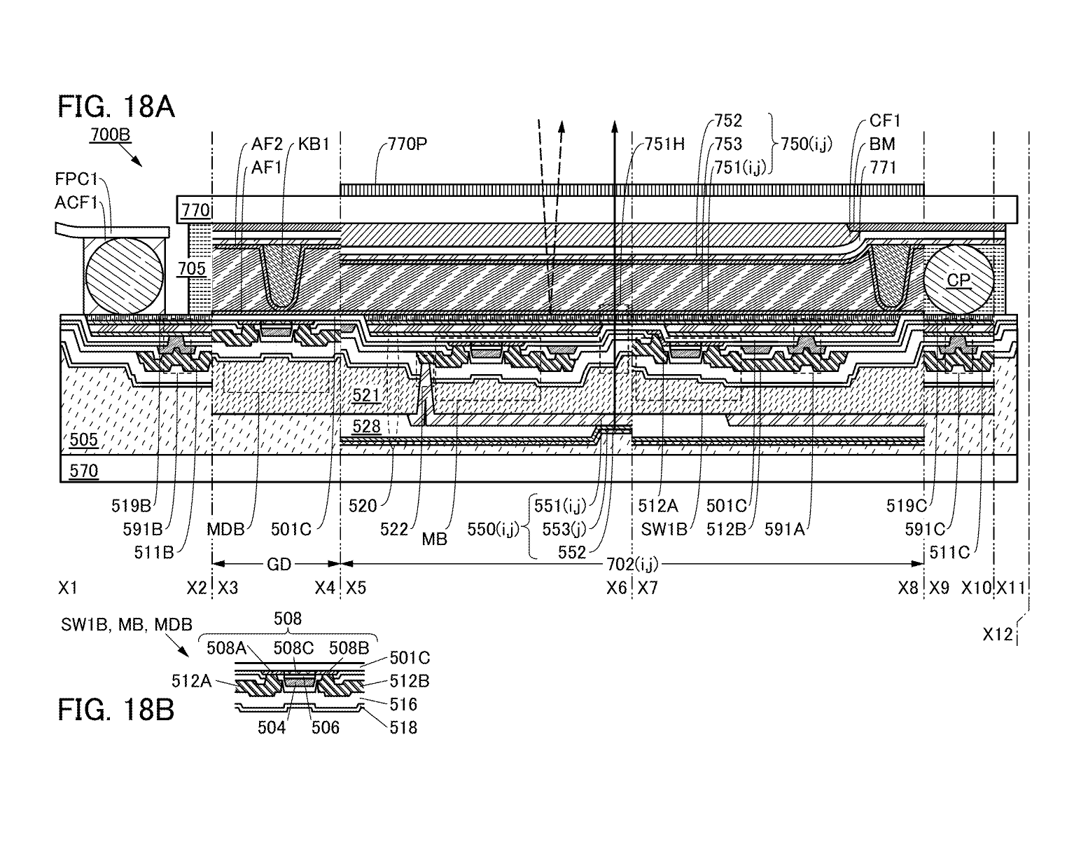

Note that the pad can be formed in the same step as the terminal 519B or the terminal 519C.

<Structure Example 2 of Display Panel>FIGS. 18A and 18B illustrate a structure of a display panel 700B. FIG. 18A is a cross-sectional view taken along lines X1-X2, X3-X4, X5-X6, X7-X8, X9-X10, and X11-X12 in FIG. 14A. FIG. 18B is a cross-sectional view illustrating part of the display panel.

Note that the display panel 700B is different from the display panel 700 in FIGS. 15A to 15C in including a top-gate transistor instead of a bottom-gate transistor. Described below are different structures, and the above description is referred to for similar structures.

### <<Switch SW1B, Transistor MB, and Transistor MDB>>

A transistor that can be used for the switch SW1B and the transistors MB and MDB include the conductive film 504 having a region overlapping with the insulating film 501C and the semiconductor film 508 having a region provided between the insulating film 501C and the conductive film 504. Note that the conductive film 504 serves as a gate electrode (see FIG. 18B).

The semiconductor film 508 includes a first region 508A, a second region 508B, and a third region 508C. The first region 508A and the second region 508B do not overlap with the conductive film 504. The third region 508C lies between the first region 508A and the second region 508B and overlaps with the conductive film 504.

The transistor MDB includes the insulating film 506 between the third region 508C and the conductive film 504. Note that the insulating film 506 serves as a gate insulating film.

The first region 508A and the second region 508B have a lower resistivity than the third region 508C, and serve as a source region and a drain region.

Note that, for example, a method for controlling the resistivity of the oxide semiconductor, which is described in the end of this embodiment, can be used as a method for forming the first region 508A and the second region 508B in the semiconductor film 508. Specifically, plasma treatment using a gas containing a rare gas can be employed.

For example, the conductive film 504 can be used as a mask, in which case the shape of part of the third region 508C can be the same as the shape of an end portion of the conductive film 504 in a self-aligned manner.

The transistor MDB includes the conductive films 512A and 512B which are in contact with the first region 508A and the second region 508B, respectively. The conductive film 512A and the conductive film 512B serve as a source electrode and a drain electrode.

A transistor that can be formed in the same step as the transistor MDB can be used as the transistor MB.

### <Method for Controlling Resistivity of Oxide Semiconductor>

A method for controlling the resistivity of an oxide semiconductor film will be described.

An oxide semiconductor film with a certain resistivity can be used as the semiconductor film 508, the conductive film 524, or the like.

For example, a method for controlling the concentration of impurities such as hydrogen and water contained in the oxide semiconductor film and/or the oxygen vacancies in the film can be used as the method for controlling the resistivity of an oxide semiconductor.

Specifically, plasma treatment can be used as a method for increasing or decreasing the concentration of impurities such as hydrogen and water and/or the oxygen vacancies in the film.

Specifically, plasma treatment using a gas containing one or more kinds selected from a rare gas (He, Ne, Ar, Kr, or Xe), hydrogen, boron, phosphorus, and nitrogen can be employed. For example, plasma treatment in an Ar atmosphere, plasma treatment in a mixed gas atmosphere of Ar and hydrogen, plasma treatment in an ammonia atmosphere, plasma treatment in a mixed gas atmosphere of Ar and ammonia, or plasma treatment in a nitrogen atmosphere can be employed. Thus, the oxide semiconductor film can have a high carrier density and a low resistivity.

Alternatively, hydrogen, boron, phosphorus, or nitrogen is added to the oxide semiconductor film by an ion implantation method, an ion doping method, a plasma immersion ion implantation method, or the like, so that the oxide semiconductor film can have a low resistivity.

Alternatively, an insulating film containing hydrogen is formed in contact with the oxide semiconductor film, and the hydrogen is diffused from the insulating film to the oxide semiconductor film, so that the oxide semiconductor film can have a high carrier density and a low resistivity.

For example, an insulating film with a hydrogen concentration of greater than or equal to 1×10²² atoms/cm³ is formed in contact with the oxide semiconductor film, whereby hydrogen can be effectively supplied to the oxide semiconductor film. Specifically, a silicon nitride film can be used as the insulating film formed in contact with the oxide semiconductor film.

Hydrogen contained in the oxide semiconductor film reacts with oxygen bonded to a metal atom to be water, and an oxygen vacancy is formed in a lattice from which oxygen is released (or a portion from which oxygen is released). Due to entry of hydrogen into the oxygen vacancy, an electron serving as a carrier is generated in some cases. Furthermore, bonding of part of hydrogen to oxygen bonded to a metal atom causes generation of an electron serving as a carrier in some cases. Thus, the oxide semiconductor film can have a high carrier density and a low resistivity.

Specifically, an oxide semiconductor with a hydrogen concentration measured by SIMS of greater than or equal to 8×10¹⁹ atoms/cm³, preferably greater than or equal to 1×10²⁰ atoms/cm³, more preferably greater than or equal to 5×10²⁰ atoms/cm³ can be suitably used for the conductive film 524.

On the other hand, an oxide semiconductor with a high resistivity can be used for a semiconductor film where a channel of a transistor is formed, specifically, the semiconductor film 508.

For example, an insulating film containing oxygen, in other words, an insulating film capable of releasing oxygen, is formed in contact with an oxide semiconductor film, and the oxygen is supplied from the insulating film to the oxide semiconductor film, so that oxygen vacancies in the film or at the interface can be filled. Thus, the oxide semiconductor film can have a high resistivity.

For example, a silicon oxide film or a silicon oxynitride film can be used as the insulating film capable of releasing oxygen.

The oxide semiconductor film in which oxygen vacancies are filled and the hydrogen concentration is reduced can be referred to as a highly purified intrinsic or substantially highly purified intrinsic oxide semiconductor film. The term “substantially intrinsic” refers to the state in which an oxide semiconductor film has a carrier density lower than 8×10¹¹/cm³, preferably lower than 1×10¹¹/cm³, further preferably lower than 1×10¹⁰/cm³. A highly purified intrinsic or substantially highly purified intrinsic oxide semiconductor film has few carrier generation sources and thus can have a low carrier density. The highly purified intrinsic or substantially highly purified intrinsic oxide semiconductor film has a low density of defect states and accordingly can have a low density of trap states.

Furthermore, a transistor including the highly purified intrinsic or substantially highly purified intrinsic oxide semiconductor film has an extremely low off-state current; even when an element has a channel width of 1×10⁶ μm and a channel length L of 10 μm, the off-state current can be lower than or equal to the measurement limit of a semiconductor parameter analyzer, that is, lower than or equal to 1×10⁻¹³ A, at a voltage (drain voltage) between a source electrode and a drain electrode of from 1 V to 10 V.

The transistor in which a channel region is formed in the oxide semiconductor film that is a highly purified intrinsic or substantially highly purified intrinsic oxide semiconductor film can have a small change in electrical characteristics and high reliability.

Specifically, an oxide semiconductor whose hydrogen concentration measured by SIMS is lower than or equal to 2×10²⁰ atoms/cm³, preferably lower than or equal to 5×10¹⁹ atoms/cm³, more preferably lower than or equal to 1×10¹⁹ atoms/cm³, more preferably lower than 5×10¹⁸ atoms/cm³, more preferably lower than or equal to 1×10¹⁸ atoms/cm³, more preferably lower than or equal to 5×10¹⁷ atoms/cm³, more preferably lower than or equal to 1×10¹⁶ atoms/cm³ can be favorably used for a semiconductor film where a channel of a transistor is formed.

Note that an oxide semiconductor film that has a higher hydrogen concentration and/or a larger number of oxygen vacancies and that has a lower resistivity than the semiconductor film 508 is used as the conductive film 524.

A film whose hydrogen concentration is twice or more, preferably ten times or more that of the semiconductor film 508 can be used as the conductive film 524.

A film whose resistivity is greater than or equal to 1×10⁻⁸ times and less than 1×10⁻¹ times that of the semiconductor film 508 can be used as the conductive film 524.

Specifically, a film whose resistivity is higher than or equal to 1×10⁻³ Ωcm and lower than 1×10⁴ Ωcm, preferably higher than or equal to 1×10⁻³ Ωcm and lower than 1×10⁻¹ Ωcm can be used as the conductive film 524.

Note that this embodiment can be combined with any of the other embodiments in this specification as appropriate.

### Embodiment 4

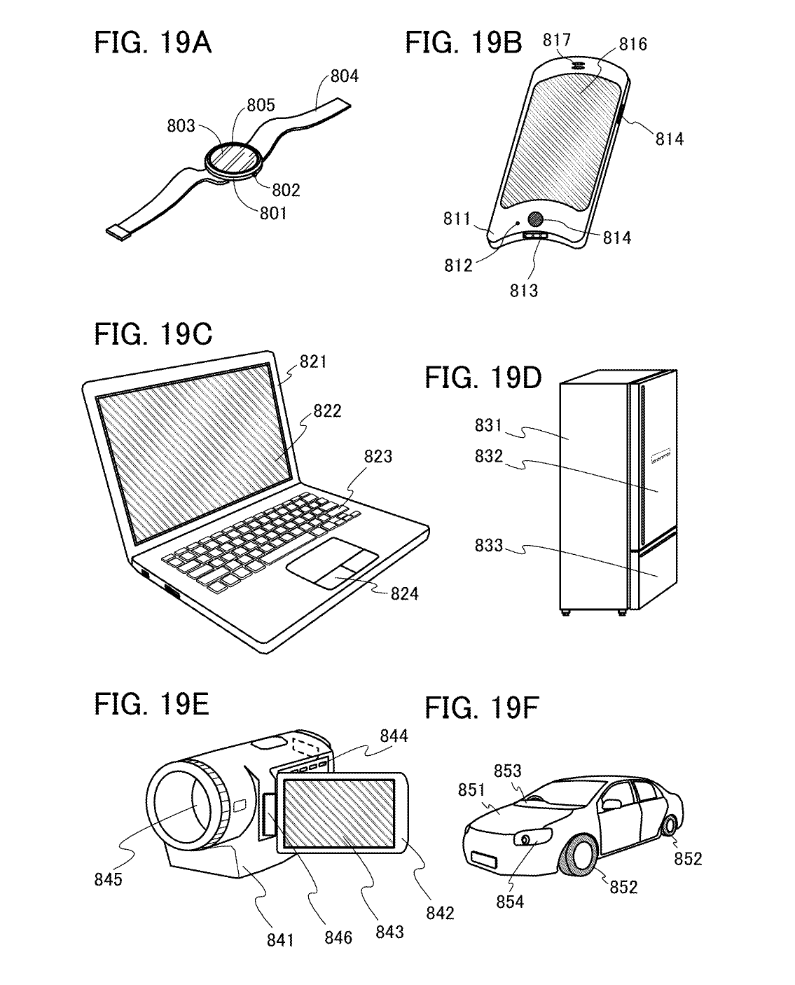

The power storage device according to one embodiment of the present invention can be used for vehicles such as an automobile, a motorcycle, and a bicycle, aircrafts, ships, home-use storage batteries, and the like. The power storage device according to one embodiment of the present invention can also be used for electronic devices such as a cellular phone, a wristwatch, a portable game machine, a portable data terminal, an e-book reader, a video camera, a digital still camera, a goggle-type display (head-mounted display), and the like. Specific examples of them are illustrated in FIGS. 19A to 19F.

FIG. 19A illustrates a wristwatch-type terminal, which includes a housing 801, a winder 802, a display portion 803, a belt 804, a sensor portion 805, and the like. The display portion 803 may include a touch panel. A user can input information by using finger touching the touch panel as a pointer.

The sensor portion 805 is configured to acquire information by measuring the surrounding state. For example, a camera, an acceleration sensor, a direction sensor, a pressure sensor, a temperature sensor, a humidity sensor, an illuminance sensor, or a global positioning system (GPS) signal receiving circuit can be used as the sensor portion 805.

For example, when an arithmetic device in the housing 801 determines that the ambient light level measured by an illuminance sensor of the sensor portion 805 is sufficiently higher than the predetermined illuminance, a reflective liquid crystal element is used as a display element of the display portion 803. In the case where the arithmetic device determines that the ambient light level is low, an organic EL element is used as a display element of the display portion 803. Thus, image information can be displayed in such a manner that, for example, a reflective display element is used in an environment with strong external light and a self-luminous display element is used in a dim environment. As a result, power consumption of the electronic device can be reduced.

FIG. 19B illustrates a cellular phone, which includes a housing 811, a display portion 816, operation buttons 814, an external connection port 813, a speaker 817, a microphone 812, and the like. When the display portion 816 of the cellular phone illustrated in FIG. 19B is touched with a finger or the like, data can be input. Further, operations such as making a call and inputting a character can be performed by touch on the display portion 816 with a finger or the like. The power can be turned on or off with the operation button 814. In addition, types of images displayed on the display portion 816 can be switched; for example, switching images from a mail creation screen to a main menu screen is performed with the operation button 814.

FIG. 19C illustrates a laptop personal computer, which includes a housing 821, a display portion 822, a keyboard 823, a pointing device 824, and the like.

FIG. 19D illustrates an electric refrigerator-freezer, which includes a housing 831, a refrigerator door 832, a freezer door 833, and the like.

FIG. 19E illustrates a video camera, which includes a first housing 841, a second housing 842, a display portion 843, operation keys 844, a lens 845, a joint 846, and the like. The operation keys 844 and the lens 845 are provided for the first housing 841, and the display portion 843 is provided for the second housing 842. The first housing 841 and the second housing 842 are connected to each other with the joint 846, and the angle between the first housing 841 and the second housing 842 can be changed with the joint 846. Images displayed on the display portion 843 may be switched in accordance with the angle at the joint 846 between the first housing 841 and the second housing 842.

FIG. 19F illustrates a car, which includes a car body 851, wheels 852, a dashboard 853, lights 854, and the like.

### Embodiment 5

In this embodiment, crystal structures of an oxide semiconductor that can be used for the OS transistors described in the above embodiments are described.

In this specification, the term “parallel” indicates that the angle formed between two straight lines is greater than or equal to −10° and less than or equal to 10°, and accordingly also includes the case where the angle is greater than or equal to −5° and less than or equal to 5°. In addition, the term “substantially parallel” indicates that the angle formed between two straight lines is greater than or equal to −30° and less than or equal to 30°. The term “perpendicular” indicates that the angle formed between two straight lines is greater than or equal to 80° and less than or equal to 100°, and accordingly also includes the case where the angle is greater than or equal to 85° and less than or equal to 95°. In addition, the term “substantially perpendicular” indicates that the angle formed between two straight lines is greater than or equal to 60° and less than or equal to 120°.

In this specification, trigonal and rhombohedral crystal systems are included in a hexagonal crystal system.

An oxide semiconductor film is classified into a non-single-crystal oxide semiconductor film and a single crystal oxide semiconductor film. Alternatively, an oxide semiconductor is classified into, for example, a crystalline oxide semiconductor and an amorphous oxide semiconductor.

Examples of a non-single-crystal oxide semiconductor include a c-axis-aligned a-b-plane-anchored crystalline oxide semiconductor (CAAC-OS), a polycrystalline oxide semiconductor, a microcrystalline oxide semiconductor, and an amorphous oxide semiconductor. In addition, examples of a crystalline oxide semiconductor include a single crystal oxide semiconductor, a CAAC-OS, a polycrystalline oxide semiconductor, and a microcrystalline oxide semiconductor.

First, a CAAC-OS film will be described.

The CAAC-OS film is one of oxide semiconductor films having a plurality of c-axis aligned crystal parts.

In a combined analysis image (also referred to as a high-resolution TEM image) of a bright-field image and a diffraction pattern of a CAAC-OS film, which is obtained using a transmission electron microscope (TEM), a plurality of crystal parts can be observed. However, in the high-resolution TEM image, a boundary between crystal parts, that is, a grain boundary is not clearly observed. Thus, in the CAAC-OS film, a reduction in electron mobility due to the grain boundary is less likely to occur.

According to the high-resolution cross-sectional TEM image of the CAAC-OS film observed in a direction substantially parallel to a sample surface, metal atoms are arranged in a layered manner in the crystal parts. Each metal atom layer has a morphology reflecting unevenness of a surface where the CAAC-OS film is formed (hereinafter, a surface where the CAAC-OS film is formed is also referred to as a formation surface) or a top surface of the CAAC-OS film, and is arranged parallel to the formation surface or the top surface of the CAAC-OS film.

On the other hand, according to the high-resolution plan-view TEM image of the CAAC-OS film observed in a direction substantially perpendicular to the sample surface, metal atoms are arranged in a triangular or hexagonal configuration in the crystal parts. However, there is no regularity of arrangement of metal atoms between different crystal parts.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

Note that when the CAAC-OS film with an InGaZnO₄ crystal is analyzed by an out-of-plane method, a peak may also be observed when 2θ is around 36°, in addition to the peak at 2θ of around 31°. The peak at 2θ of around 36° indicates that a crystal having no c-axis alignment is included in part of the CAAC-OS film. It is preferable that in the CAAC-OS film, a peak appear when 2θ is around 31° and that a peak not appear when 2θ is around 36°.

The CAAC-OS film is an oxide semiconductor film having low impurity concentration. The impurity is an element other than the main components of the oxide semiconductor film, such as hydrogen, carbon, silicon, or a transition metal element. In particular, an element that has higher bonding strength to oxygen than a metal element included in the oxide semiconductor film, such as silicon, disturbs the atomic arrangement of the oxide semiconductor film by depriving the oxide semiconductor film of oxygen and causes a decrease in crystallinity. Furthermore, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein.

The state in which impurity concentration is low and density of defect states is low (the number of oxygen vacancies is small) is referred to as a highly purified intrinsic or substantially highly purified intrinsic state. A highly purified intrinsic or substantially highly purified intrinsic oxide semiconductor film has few carrier generation sources, and thus can have a low carrier density. Therefore, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has little variation in electrical characteristics and high reliability. Electric charges trapped by the carrier traps in the oxide semiconductor film take a long time to be released and might behave like fixed electric charges. Thus, the transistor including the oxide semiconductor film having high impurity concentration and a high density of defect states has unstable electrical characteristics in some cases.

With the use of the CAAC-OS film in a transistor, variation in the electrical characteristics of the transistor due to irradiation with visible light or ultraviolet light is small.

Next, a microcrystalline oxide semiconductor film will be described.

A microcrystalline oxide semiconductor film has a region in which a crystal part is observed and a region in which a crystal part is not clearly observed in a high-resolution TEM image. In most cases, the size of a crystal part included in the microcrystalline oxide semiconductor film is greater than or equal to 1 nm and less than or equal to 100 nm, or greater than or equal to 1 nm and less than or equal to 10 nm. A microcrystal with a size greater than or equal to 1 nm and less than or equal to 10 nm, or a size greater than or equal to 1 nm and less than or equal to 3 nm, is specifically referred to as nanocrystal (nc). An oxide semiconductor film including nanocrystal is referred to as an nc-OS (nanocrystalline oxide semiconductor) film. In a high-resolution TEM image of the nc-OS film, for example, a grain boundary is not clearly observed in some cases.

In the nc-OS film, a microscopic region (for example, a region with a size greater than or equal to 1 nm and less than or equal to 10 nm, in particular, a region with a size greater than or equal to 1 nm and less than or equal to 3 nm) has a periodic atomic arrangement. There is no regularity of crystal orientation between different crystal parts in the nc-OS film. Thus, the orientation of the whole film is not observed. Accordingly, in some cases, the nc-OS film cannot be distinguished from an amorphous oxide semiconductor film depending on an analysis method. For example, when the nc-OS film is subjected to structural analysis by an out-of-plane method with an XRD apparatus using an X-ray having a diameter larger than the size of a crystal part, a peak indicating a crystal plane does not appear. Furthermore, a halo pattern is shown in a selected-area electron diffraction pattern of the nc-OS film obtained by using an electron beam having a probe diameter (e.g., 50 nm or larger) larger than the size of a crystal part. Meanwhile, spots are shown in a nanobeam electron diffraction pattern of the nc-OS film obtained by using an electron beam having a probe diameter close to or smaller than the size of a crystal part. Furthermore, in a nanobeam electron diffraction pattern of the nc-OS film, regions with high luminance in a circular (ring) pattern are shown in some cases. Moreover, in a nanobeam electron diffraction pattern of the nc-OS film, a plurality of spots are shown in a ring-like region in some cases.

The nc-OS film is an oxide semiconductor film that has high regularity as compared with an amorphous oxide semiconductor film. Therefore, the nc-OS film has a lower density of defect states than an amorphous oxide semiconductor film. Note that there is no regularity of crystal orientation between different crystal parts in the nc-OS film. Therefore, the nc-OS film has a higher density of defect states than the CAAC-OS film.

Next, an amorphous oxide semiconductor film is described.

The amorphous oxide semiconductor film has disordered atomic arrangement and no crystal part. For example, the amorphous oxide semiconductor film does not have a specific state as in quartz.

In a high-resolution TEM image of the amorphous oxide semiconductor film, crystal parts cannot be found.

When the amorphous oxide semiconductor film is subjected to structural analysis by an out-of-plane method with an XRD apparatus, a peak which shows a crystal plane does not appear. A halo pattern is observed when the amorphous oxide semiconductor film is subjected to electron diffraction. Furthermore, a spot is not observed and a halo pattern appears when the amorphous oxide semiconductor film is subjected to nanobeam electron diffraction.

Note that an oxide semiconductor film may have a structure having physical properties between the nc-OS film and the amorphous oxide semiconductor film. The oxide semiconductor film having such a structure is specifically referred to as an amorphous-like oxide semiconductor (a-like OS) film.

In a high-resolution TEM image of the a-like OS film, a void may be observed. Furthermore, in the high-resolution TEM image, there are a region where a crystal part is clearly observed and a region where a crystal part is not observed. In some cases, growth of the crystal part occurs due to the crystallization of the a-like OS film, which is induced by a slight amount of electron beam employed in the TEM observation. In contrast, in the nc-OS film that has good quality, crystallization hardly occurs by a slight amount of electron beam used for TEM observation.

Note that the crystal part size in the a-like OS film and the nc-OS film can be measured using high-resolution TEM images. For example, an InGaZnO₄ crystal has a layered structure in which two Ga—Zn—O layers are included between In—O layers. A unit cell of the InGaZnO₄ crystal has a structure in which nine layers including three In—O layers and six Ga—Zn—O layers are stacked in the c-axis direction. Accordingly, the distance between the adjacent layers is equivalent to the lattice spacing on the (009) plane (also referred to as d value). The value is calculated to be 0.29 nm from crystal structural analysis. Thus, focusing on lattice fringes in the high-resolution TEM image, each of lattice fringes in which the lattice spacing therebetween is greater than or equal to 0.28 nm and less than or equal to 0.30 nm corresponds to the a-b plane of the InGaZnO₄ crystal.

Furthermore, the density of an oxide semiconductor film varies depending on the structure in some cases. For example, when the composition of an oxide semiconductor film is determined, the structure of the oxide semiconductor film can be expected by comparing the density of the oxide semiconductor film with the density of a single crystal oxide semiconductor film having the same composition as the oxide semiconductor film. For example, the density of the a-like OS film is higher than or equal to 78.6% and lower than 92.3% of the density of the single crystal oxide semiconductor film having the same composition. For example, the density of each of the nc-OS film and the CAAC-OS film is higher than or equal to 92.3% and lower than 100% of the density of the single crystal oxide semiconductor film having the same composition. Note that it is difficult to deposit an oxide semiconductor film having a density of lower than 78% of the density of the single crystal oxide semiconductor film.

Specific examples of the above description are given. For example, in the case of an oxide semiconductor film having an atomic ratio of In:Ga:Zn=1:1:1, the density of single crystal InGaZnO₄ with a rhombohedral crystal structure is 6.357 g/cm³. Accordingly, in the case of the oxide semiconductor film having an atomic ratio of In:Ga:Zn=1:1:1, the density of the a-like OS film is higher than or equal to 5.0 g/cm³ and lower than 5.9 g/cm³. For example, in the case of the oxide semiconductor film having an atomic ratio of In:Ga:Zn=1:1:1, the density of each of the nc-OS film and the CAAC-OS film is higher than or equal to 5.9 g/cm³ and lower than 6.3 g/cm³.

Note that there is a possibility that an oxide semiconductor having a certain composition cannot exist in a single crystal structure. In that case, single crystal oxide semiconductor films with different compositions are combined at an adequate ratio, which makes it possible to calculate density equivalent to that of a single crystal oxide semiconductor with the desired composition. The density of a single crystal oxide semiconductor having the desired composition can be calculated using a weighted average according to the combination ratio of the single crystal oxide semiconductors with different compositions. Note that it is preferable to use as few kinds of single crystal oxide semiconductors as possible to calculate the density.

Note that an oxide semiconductor film may be a stacked film including two or more films of an amorphous oxide semiconductor film, an a-like OS film, a microcrystalline oxide semiconductor film, and a CAAC-OS film, for example.

In this specification and the like, terms for describing arrangement, such as “over” and “under”, are used for convenience to indicate a positional relation between components with reference to drawings. The positional relation between components is changed as appropriate in accordance with a direction in which the components are described. Therefore, the terms for explaining arrangement are not limited to those used in this specification and may be changed to other terms as appropriate depending on the situation.

Furthermore, in a block diagram in this specification and the like, components are functionally classified and shown by blocks that are independent of each other. However, in an actual circuit and the like, such components are sometimes hard to classify functionally, and there is a case where one circuit is associated with a plurality of functions or a case where a plurality of circuits are associated with one function. Therefore, the segmentation of blocks in a block diagram is not limited by any of the components described in the specification and can be differently determined as appropriate depending on the situation.

In this specification and the like, the terms “one of a source and a drain” (or first electrode or first terminal) and “the other of the source and the drain” (or second electrode or second terminal) are used to describe the connection relation of a transistor. This is because a source and a drain of a transistor are interchangeable depending on the structure, operation conditions, or the like of the transistor. Note that the source or the drain of the transistor can also be referred to as a source (or drain) terminal, a source (or drain) electrode, or the like as appropriate depending on the situation.

In addition, in this specification and the like, the term such as “electrode” or “wiring” does not limit a function of a component. For example, an “electrode” is used as part of a “wiring” in some cases, and vice versa. Moreover, the term “electrode” or “wiring” can also mean a combination of a plurality of electrodes or wirings formed in an integrated manner.

In this specification and the like, “voltage” and “potential” can be replaced with each other. The term “voltage” refers to a potential difference from a reference potential. When the reference potential is a ground potential, for example, “voltage” can be replaced with “potential”. The ground potential does not necessarily mean 0 V. Potentials are relative values, and a potential supplied to a wiring or the like is sometimes changed depending on the reference potential.

In this specification and the like, the terms “film” and “layer” can be interchanged with each other depending on the case or circumstances. For example, the term “conductive layer” can be changed into the term “conductive film” in some cases. Also, the term “insulating film” can be changed into the term “insulating layer” in some cases.

In this specification and the like, a switch is in a conductive state (on state) or in a non-conductive state (off state) to determine whether current flows therethrough or not. Alternatively, a switch has a function of selecting and changing a current path.

Examples of a switch are an electrical switch, a mechanical switch, and the like. That is, any element can be used as a switch as long as it can control current, without limitation to a certain element.

Examples of the electrical switch are a transistor (e.g., a bipolar transistor or a MOS transistor), a diode (e.g., a PN diode, a PIN diode, a Schottky diode, a metal-insulator-metal (MIM) diode, a metal-insulator-semiconductor (MIS) diode, or a diode-connected transistor), and a logic circuit in which such elements are combined.

In the case of using a transistor as a switch, an “on state” of the transistor refers to a state in which a source and a drain of the transistor are electrically short-circuited. Furthermore, an “off state” of the transistor refers to a state in which the source and the drain of the transistor are electrically disconnected. In the case where a transistor operates just as a switch, the polarity (conductivity type) of the transistor is not particularly limited to a certain type.

An example of the mechanical switch is a switch formed using a micro electro mechanical systems (MEMS) technology, such as a digital micromirror device (DMD). Such a switch includes an electrode which can be moved mechanically, and operates by controlling conduction and non-conduction in accordance with movement of the electrode.

For example, in this specification and the like, an explicit description “X and Y are connected” means that X and Y are electrically connected, X and Y are functionally connected, and X and Y are directly connected. Accordingly, without being limited to a predetermined connection relation, for example, a connection relation shown in drawings or text, another connection relation is included in the drawings or the text.

Here, X and Y each denote an object (e.g., a device, an element, a circuit, a wiring, an electrode, a terminal, a conductive film, and a layer).

Examples of the case where X and Y are directly connected include the case where an element that enables electrical connection between X and Y (e.g., a switch, a transistor, a capacitor, an inductor, a resistor, a diode, a display element, a light-emitting element, and a load) is not connected between X and Y, and the case where X and Y are connected without the element that enables electrical connection between X and Y provided therebetween.

For example, in the case where X and Y are electrically connected, one or more elements that enable electrical connection between X and Y (e.g., a switch, a transistor, a capacitor, an inductor, a resistor, a diode, a display element, a light-emitting element, and a load) can be connected between X and Y. Note that the case where X and Y are electrically connected includes the case where X and Y are directly connected.

For example, in the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit; a potential level converter circuit such as a power supply circuit (e.g., a step-up circuit or a step-down circuit) or a level shifter circuit for changing the potential level of a signal; a voltage source; a current source; a switching circuit; an amplifier circuit such as a circuit capable of increasing signal amplitude, the amount of current, or the like, an operational amplifier, a differential amplifier circuit, a source follower circuit, and a buffer circuit; a signal generation circuit; a memory circuit; and/or a control circuit) can be connected between X and Y. For example, in the case where a signal output from X is transmitted to Y even when another circuit is placed between X and Y, X and Y are functionally connected. Note that the case where X and Y are functionally connected includes the case where X and Y are directly connected and the case where X and Y are electrically connected.

Note that in this specification and the like, an explicit description “X and Y are electrically connected” means that X and Y are electrically connected (i.e., the case where X and Y are connected with another element or another circuit provided therebetween), X and Y are functionally connected (i.e., the case where X and Y are functionally connected with another circuit provided therebetween), and X and Y are directly connected (i.e., the case where X and Y are connected without another element or another circuit provided therebetween). That is, in this specification and the like, the explicit description “X and Y are electrically connected” is the same as the description “X and Y are connected”.

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y.

Examples of the expressions include, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit structure is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path”. Another example of the expression is “a source (or a first terminal or the like) of a transistor is electrically connected to X at least with a first connection path through Z1, the first connection path does not include a second connection path, the second connection path includes a connection path through which the transistor is provided, a drain (or a second terminal or the like) of the transistor is electrically connected to Y at least with a third connection path through Z2, and the third connection path does not include the second connection path”. Still another example of the expression is “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit structure is defined by an expression similar to the above examples, a source (or a first terminal or the like) and a drain (or a second terminal or the like) of a transistor can be distinguished from each other to specify the technical scope.

Note that these expressions are examples and there is no limitation on the expressions. Here, X, Y, Z1, and Z2 each denote an object (e.g., a device, an element, a circuit, a wiring, an electrode, a terminal, a conductive film, and a layer).

Even when independent components are electrically connected to each other in a circuit diagram, one component has functions of a plurality of components in some cases. For example, when part of a wiring also functions as an electrode, one conductive film functions as the wiring and the electrode. Thus, “electrical connection” in this specification includes in its category such a case where one conductive film has functions of a plurality of components.

This application is based on Japanese Patent Application serial no. 2015-170113 filed with Japan Patent Office on Aug. 31, 2015, the entire contents of which are hereby incorporated by reference.

What is claimed is:

1. A power storage device comprising:
a power storage element; and
an integrated circuit comprising a first circuit, a second circuit and an amplifier circuit, the integrated circuit configured to monitor an electromotive force of the power storage element,
wherein the first circuit is configured to supply a bias voltage to the amplifier circuit through the second circuit, and
wherein the second circuit is configured to hold the bias voltage.

2. The power storage device according to claim 1,
wherein the second circuit comprises a first transistor and a capacitor,
wherein the amplifier circuit comprises a second transistor,
wherein the first circuit is electrically connected to a gate of the second transistor through the first transistor,
wherein a first terminal of the capacitor is electrically connected to the gate of the second transistor, and
wherein the first transistor comprises an oxide semiconductor in a channel formation region.

3. The power storage device according to claim 2, wherein the integrated circuit further comprises a timer configured to determine a timing of turning on and off the first transistor.

4. A power storage device comprising:
a plurality of power storage elements connected in series; and
an integrated circuit comprising a circuit configured to select at least one of the plurality of power storage elements,
wherein the integrated circuit is configured to monitor an electromotive force of at least the one of the plurality of power storage elements selected by the circuit, and
wherein the circuit comprises a transistor comprising an oxide semiconductor in a channel formation region.

5. An electronic device comprising:
the power storage device according to claim 1; and
a display.

6. The electronic device according to claim 5,
wherein the display comprises:
a first display element comprising a reflective film, the reflective film comprising an opening; and
a second display element,
wherein the reflective film is capable of reflecting incident light,
wherein the first display element is configured to adjust intensity of reflected light, and
wherein the second display element is configured to emit light toward the opening.

7. The electronic device according to claim 6,
wherein the first display element comprises a liquid crystal element, and
wherein the second display element comprises an organic EL element.

8. A power storage device comprising:
a first power storage element; and
a circuit configured to monitor an electromotive force of the first power storage element, the circuit comprising:
a holding circuit comprising:
a first transistor comprising an oxide semiconductor; and
a capacitor;
an amplifier circuit comprising a second transistor; and
a bias circuit configured to supply a bias voltage to the amplifier circuit through the holding circuit,
wherein one of a source and a drain of the first transistor is electrically connected to the bias circuit, and
wherein the other of the source and the drain of the first transistor is electrically connected to a first terminal of the capacitor and a gate of the second transistor.

9. The power storage device according to claim 8, wherein the circuit further comprises a timer configured to determine a timing of turning on and off the first transistor.

10. The power storage device according to claim 8, further comprising:
a second power storage element;
a third power storage element; and
a selector configured to select at least one of the first power storage element, the second power storage element and the third power storage element,
wherein the first power storage element, the second power storage element and the third power storage element is connected in series, and
wherein the circuit is configured to monitor an electromotive force of each of the second power storage element and the third power storage element through the selector.

11. The power storage device according to claim 10,
wherein the selector comprises:
a third transistor comprising an oxide semiconductor; and
a fourth transistor comprising a wide band gap semiconductor,
wherein a source of the third transistor is electrically connected to a source of the fourth transistor, and
wherein a drain of the third transistor is electrically connected to a drain of the fourth transistor.

12. The power storage device according to claim 11,
wherein the third transistor is an n-channel transistor, and
wherein the fourth transistor is a p-channel transistor.

13. An electronic device comprising:
the power storage device according to claim 8; and
a display.

14. The electronic device according to claim 13,
wherein the display comprises:
a first display element comprising a reflective film, the reflective film comprising an opening; and
a second display element,
wherein the second display element and the opening overlap each other.

15. The electronic device according to claim 14,
wherein the first display element comprises a liquid crystal element, and
wherein the second display element comprises an organic EL element.
